(19) United States
(12) Patent Application Publication
(10) Pub. No.: US 2010/0099322 A1
(43) Pub. Date: Apr. 22, 2010

(54) METHOD FOR MANUFACTURING ELECTRO-OPTICAL DEVICE AND APPARATUS FOR MANUFACTURING ELECTRO-OPTICAL DEVICE

(75) Inventors: Satoru KATAGAMI, Matsumoto (JP); Sadaharu KOMORI, Shiojiri (JP); Tsuyoshi KATO, Shiojiri (JP); Masayuki OKUYAMA, Suwa (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 12/580,606

(22) Filed: Oct. 16, 2009

(30) Foreign Application Priority Data
Oct. 21, 2008 (JP) 2008-270612

(51) Int. Cl. H01J 9/24; H01J 9/46

(52) U.S. Cl. 445/24; 445/66

(57) ABSTRACT

A method for manufacturing an electro-optical device includes performing a discharge-scanning by moving a nozzle row including a plurality of discharge nozzles and a substrate including a plurality of functional film partitioned areas relative to each other in a direction perpendicular to an array direction of the discharge nozzles in the nozzle row and by selectively discharging liquid from the discharge nozzles to deposit the liquid in the film formation partitioned areas to form a functional film, and performing a secondary scanning by moving the substrate and the nozzle row relative to each other in the array direction. The performing of the secondary scanning includes performing a first secondary scanning at least once in which a relative movement distance between the nozzle row and the substrate is equal to an integral multiple of an arrangement pitch of the film formation partitioned areas in the array direction.

### CROSS-REFERENCE TO RELATED APPLICATIONS

This application claims priority to Japanese Patent Application No. 2008-270612 filed on Oct. 21, 2008. The entire disclosure of Japanese Patent Application No. 2008-270612 is hereby incorporated herein by reference.

### BACKGROUND

1. Technical Field

The present invention relates to a method for manufacturing an electro-optical device for forming a functional film of an electro-optical device, and to an apparatus for manufacturing an electro-optical device for forming a functional film of an electro-optical device. Examples of electro-optical devices include a liquid crystal device and an organic EL (organic electro luminescence) device.

2. Related Art

There are known conventional techniques for forming a functional film such as a color filter film of a color liquid crystal device or the like in which droplets of a liquid containing a material of a functional film are discharged and made to land in arbitrary positions on a substrate using a drawing device having a droplet discharge head for discharging liquid as droplets, whereby liquid is deposited (drawn) in the positions and the deposited liquid is dried to form a functional film. The drawing device used in such film formation selectively discharges very small droplets from the discharge nozzles of a droplet discharge head while moving the droplet discharge head in a relative fashion in relation to a substrate, and a film having a precise planar shape can be formed because the droplets can be made to land with good positional accuracy on the substrate. A film having a precise thickness can be formed because the size of the very small droplets can be controlled with good precision.

There is a need to obtain a more precise planar shape and film thickness in order to form a functional film having higher function. There is also a need to deposit an accurate amount of liquid in each of the partitioned in which a functional film is to be formed in order to achieve a more precise film thickness. There is furthermore a need for the discharge amount of liquid discharged from the discharge nozzles to accurately reach a set discharge amount in order to deposit an accurate amount of the liquid.

Japanese Laid-Open Patent Application No. 2008-94044 discloses a head unit, droplet discharge device, a method for discharging liquid, a method for manufacturing a color filter, a method for manufacturing a organic EL device, and a method for manufacturing a wiring substrate, in which scanning for depositing liquid in a single partition is carried out in a plurality of cycles, and liquid discharged from different discharge nozzles for each of the scans is deposited, thereby making it possible to reduce discharge nonuniformity of the liquid caused by fluctuations in the discharge amount for each nozzle group, i.e., variability in the amount of liquid deposited in the partitions.

However, it is difficult to prevent adjacently formed discharge nozzles from affecting each other in a droplet discharge head having a plurality of discharge nozzles, and it is possible that the discharge amount will fluctuate depending on whether the peripheral discharge nozzles are on standby or are carrying out a discharge operation. Japanese Laid-Open Patent Application No. 2006-289765 discloses an inkjet printer that corrects drive pulses fed to the drive element of each nozzle of a print head in accordance with the ink discharge ratio of the nozzle array of the print head in order to improve the loss of print quality that occurs when there is variability in the number of discharges of the nozzles of the print head (droplet discharge head).

### SUMMARY

In the device disclosed in Japanese Laid-Open Patent Application No. 2006-289765, however, it is required that the discharge rate of the nozzle array be determined, corresponding correction data be acquired, the drive signal to the print head be determined for each discharge nozzle, and the drive pulse correction be implemented. A controller of the droplet discharge device must perform the work for correcting the drive pulses in order to correct the drive pulses. Time is required for performing the correction work, and the load on the controller for performing the correction work increases. It is effective to provide numerous discharge nozzles in order to efficiently carry out drawing discharges, but there is a problem in that each of the numerous nozzles must undergo an operation for correcting the numerous drive pulses in order to achieve drive pulse correction, and it is possible that more time will be required for the step for depositing the liquid. There is also a problem in that the load on the controller of the liquid discharge device is increased.

The present invention was contrived in order to solve at least a portion of the problems described above, and can be implemented in the following modes and application examples.

A method for manufacturing an electro-optical device according to a first aspect includes performing a discharge-scanning by moving a nozzle row including a plurality of discharge nozzles and a substrate including a plurality of functional film partitioned areas relative to each other in a direction perpendicular to an array direction of the discharge nozzles in the nozzle row and by selectively discharging liquid from the discharge nozzles to deposit the liquid in the film formation partitioned areas to form a functional film, and performing a secondary scanning by moving the substrate and the nozzle row relative to each other in the array direction. The performing of the secondary scanning includes performing a first secondary scanning at least once in which a relative movement distance between the nozzle row and the substrate is equal to an integral multiple of an arrangement pitch of the film formation partitioned areas in the array direction.

According to this method for manufacturing an electro-optical device, at least one cycle of the secondary scanning step is a first secondary scanning step in which the relative movement distance is an integral multiple of the arrangement pitch of the functional film partitioned areas. In the case that the relative movement distance is an integral multiple of the arrangement pitch of the functional film partitioned areas, the functional film partitioned areas and other portions facing the discharge nozzles are the same for most of the discharge nozzles in the discharge-scanning steps carried out before and after the secondary scan steps. In other words, the discharge nozzles facing, e.g., the center of the functional film partitioned areas in the discharge-scanning step prior to the first secondary scanning step face the center of the functional film partitioned areas as well following the first secondary scanning step, and the discharge nozzles facing, e.g., the boundary regions of the functional film partitioned areas face the boundary regions in later discharge-scanning steps as well. Therefore, the discharge and non-discharge states in the discharge nozzles are shared in the discharge-scanning step following the first secondary scanning step. The array of the discharge nozzles for carrying out discharges is shared in the nozzle row. Therefore, fluctuations in the discharge amount caused by fluctuations in the operating state of peripheral discharge nozzles can be reduced because the states of the adjacently formed discharge nozzles are substantially the same.

The method for manufacturing an electro-optical device as described above preferably further includes setting discharge drive conditions for each of the discharge nozzles so that the discharge drive conditions in the discharge-scanning performed after the first secondary scanning are set to the discharge drive conditions that are the same as the discharge drive conditions in the discharge-scanning carried out prior to the first secondary scanning.

According to this method for manufacturing an electro-optical device, the discharge drive conditions in the discharge-scanning step performed after the first secondary scanning step are set to be the same discharge drive conditions as the discharge drive conditions in the discharge-scanning step performed prior to the first secondary scanning step. Accordingly, the discharge drive conditions in the discharge-scanning step carried out after the first secondary scanning step are not required to be set using newly obtained suitable discharge conditions. Therefore, the time and load required for obtaining discharge drive conditions can be reduced.

In the method for manufacturing an electro-optical device as described above, the performing of the secondary scanning preferably includes performing a second secondary scanning in which the relative movement distance per cycle is equal to an integral multiple of a nozzle pitch of the discharge nozzles in the nozzle row.

According to this method for manufacturing an electro-optical device, secondary scanning is carried out for a relative movement distance that is an integral multiple of the nozzle pitch. Since the length of the nozzle row is an integral multiple of the nozzle pitch, the width in the secondary scanning direction in which the liquid is deposited in a single discharge scan cycle is also an integral multiple of the nozzle pitch. The movement distance in the second scan can be readily set to a suitable amount by setting the relative movement distance to an integral multiple of the nozzle pitch when the second scan is carried out in accordance with the width of the discharge scan for depositing liquid.

In the method for manufacturing an electro-optical device as described above, the setting of the discharge drive conditions preferably includes setting the discharge drive conditions so that the discharge drive conditions performed after the second secondary scanning are set to the discharge drive conditions that are different than the discharge drive conditions carried out prior to the second secondary scanning.

According to this method for manufacturing an electro-optical device, the discharge drive conditions are changed in the discharge-scanning step performed after the second secondary scanning step. In the case that the relative movement distance in the secondary scanning step is an integral multiple of the nozzle pitch, the functional film partitioned areas and other portions faced by the discharge nozzles are different for most of the discharge nozzles before and after the secondary scanning step. Therefore, the arrangement pattern of the discharge nozzles for carrying out discharges in the nozzle row will also be different. Accordingly, it is possible that the discharge amount will vary because the discharge and standby states of the discharge nozzles in the vicinity of the discharge nozzles are also different. Variation of the discharge amount can be reduced by setting the discharge drive conditions to different discharge drive conditions.

The method for manufacturing an electro-optical device as described above further includes adjusting a spacing between a plurality of the nozzle rows in the array direction to be equal to an integral multiple of the arrangement pitch.

According to this method for manufacturing an electro-optical device, since the spacing of the nozzle rows is adjusted to be an integral multiple of the arrangement pitch, the width in the secondary scanning direction in which a single nozzle row deposits the liquid in a single discharge scan cycle is set to be an integral multiple of the arrangement pitch, whereby the width of the region in which the liquid is not deposited between the nozzle rows is also made to be an integral multiple of the arrangement pitch. Therefore, the movement distance in the secondary scan can also be set to be an integral multiple of the arrangement pitch when the nozzle row moves in a region in which the liquid has not been deposited between the nozzle rows after the discharge scan.

The method for manufacturing an electro-optical device as described above preferably further includes adjusting a spacing between a plurality of the nozzle rows in the array direction to be equal to an integral multiple of the nozzle pitch.

According to this method for manufacturing an electro-optical device, since the spacing of the nozzle rows is adjusted to be an integral multiple of the nozzle pitch, the width of the region in which the liquid is not deposited between the nozzle rows is also made to be an integral multiple of the nozzle pitch. Therefore, the movement distance in the secondary scan can be set to be an integral multiple of the nozzle pitch when the nozzle row moves in a region in which the liquid has not been deposited between the nozzle rows after the discharge scan, whereby the discharge nozzles can be made to efficiently face, without excess or insufficiency, the region in which the liquid has not been deposited between the nozzle rows.

The method for manufacturing an electro-optical device as described above preferably further includes providing as the substrate a mother panel including a plurality of electro-optical panels each corresponding to a single electro-optical device so that a plurality of functional film formation regions of the electro-optical panel are arranged in the secondary scanning direction in an integral multiple of the arrangement pitch.

According to this method for manufacturing an electro-optical device, the functional film formation regions are arranged and formed in an integral multiple of the arrangement pitch. Therefore, the movement distance in the secondary scan for moving in a relative fashion the nozzle row facing a single functional film formation region to a position that faces the next functional film formation region can be set to be an integral multiple of the functional film pitch.

An apparatus for manufacturing an electro-optical device according to a second aspect includes a nozzle row, a movement mechanism and a control section. The nozzle row includes a plurality of discharge nozzles. The movement mechanism is configured and arranged to move the nozzle row and a substrate including a plurality of functional film partitioned areas relative to each other. The control section is configured to control the movement mechanism and the nozzle row to perform a discharge-scanning by moving the nozzle row and the substrate relative to each other in a direction perpendicular to an array direction of the discharge nozzles in the nozzle row and by selectively discharging liquid from the discharge nozzles to deposit the liquid in the film formation partitioned areas to form a functional film, and to control the movement mechanism to perform a secondary scanning by moving the substrate and the nozzle row relative to each other in the array direction. The control section is configured to control the movement mechanism to perform a first secondary scanning in which a relative movement distance between the nozzle row and the substrate is equal to an integral multiple of an arrangement pitch of the film formation partitioned areas in the array direction.

According to this apparatus for manufacturing an electro-optical device, the movement distance in at least one cycle of the secondary scan is an integral multiple of the arrangement pitch of the functional film partitioned areas. In the case that the movement distance is an integral multiple of the arrangement pitch of the functional film partitioned areas, the film formation partitioned areas and other portions facing the discharge nozzles is the same for most of the discharge nozzles in the discharge-scanning steps carried out before and after the secondary scan steps. In other words, the discharge nozzles facing, e.g., the center of the functional film partitioned areas in the discharge scan prior to the secondary scan face the center of the film formation partitioned areas in the discharge scan following the secondary scan as well. The discharge nozzles facing, e.g., the boundary regions of the functional film partitioned areas also face the boundary regions in the subsequent secondary scan. Therefore, the discharge and non-discharge states in the discharge nozzles are shared in the discharge scan prior to and following the secondary scan. The array of the discharge nozzles for carrying out discharges are shared in the nozzle row. Therefore, fluctuations in the discharge amount caused by fluctuations in the operating state of peripheral discharge nozzles can be reduced because the states of the adjacently formed discharge nozzles are substantially the same.

The apparatus for manufacturing an electro-optical device as described above preferably further includes a drive conditions setting section configured and arranged to set discharge drive conditions for each of the discharge nozzles so that the discharge drive conditions in the discharge-scanning performed after the first secondary scanning are set to the discharge drive conditions that are the same as the discharge drive conditions in the discharge-scanning carried out prior to the first secondary scanning.

According to this apparatus for manufacturing an electro-optical device, the discharge scans performed before and after the secondary scan in which the relative movement distance is an integral multiple of the arrangement pitch are set to the same discharge drive conditions. Accordingly, suitable discharge conditions are not required to be newly obtained in relation to the discharge drive conditions in the discharge scans performed before and after the secondary scan in which the relative movement distance is an integral multiple of the arrangement pitch. Therefore, the time and load required for obtaining discharge drive conditions can be reduced.

In the apparatus for manufacturing an electro-optical device as described above, the control section is preferably configured to control the movement mechanism to perform a second secondary scanning in which the relative movement distance per cycle is equal to an integral multiple of a nozzle pitch of the discharge nozzles in the nozzle row. The drive conditions setting section is preferably configured to set the discharge drive conditions so that the discharge drive conditions performed after the second secondary scanning are set to the discharge drive conditions that are different than the discharge drive conditions carried out prior to the second secondary scanning.

According to this apparatus for manufacturing an electro-optical device, the relative movement distance of at least one cycle of the secondary scan is an integral multiple of the nozzle pitch of the discharge nozzles in the nozzle row, and the drive condition setting section sets the discharge scans carried out before and after the secondary scan in which the relative movement distance is an integral multiple of the nozzle pitch to different discharge drive conditions. In the case that the relative movement distance in the secondary scan is an integral multiple of the nozzle pitch, the functional film partitioned areas and other portions facing the discharge nozzles are different for most of the discharge nozzles before and after the secondary scan. Therefore, the array pattern of the discharge nozzles for performing discharges is also different in the nozzle rows. Therefore, since the discharge and non-discharge states of the discharge nozzles in the vicinity of the discharge nozzles also vary, it is possible that the discharge amounts will vary. The variation in the discharge amount can be reduced by setting the discharge drive conditions to be different discharge drive conditions in the discharge scans performed before and after the secondary scan in which the relative movement distance is an integral multiple of the nozzle pitch.

The apparatus for manufacturing an electro-optical device as described above preferably further includes a plurality of the nozzle rows with a spacing between the nozzle rows in the array direction is equal to an integral multiple of the arrangement pitch.

According to this apparatus for manufacturing an electro-optical device, since the spacing of the nozzle rows is an integral multiple of the arrangement pitch, the width in the secondary scanning direction in which a single nozzle row deposits the liquid in a single discharge scan cycle is set to be an integral multiple of the arrangement pitch, whereby the width of the region in which the liquid is not deposited between the nozzle rows is also made to be an integral multiple of the arrangement pitch. Therefore, the movement distance in the secondary scan can also be set to be an integral multiple of the arrangement pitch when the nozzle row moves in a region in which the liquid has not been deposited between the nozzle rows after the discharge scan.

The apparatus for manufacturing an electro-optical device as described above preferably further includes a plurality of the nozzle rows with a spacing between the nozzle rows in the array direction is equal to an integral multiple of the nozzle pitch.

According to this apparatus for manufacturing an electro-optical device, since the spacing of the nozzle rows is an integral multiple of the nozzle pitch, the width of the region in which the liquid is not deposited between the nozzle rows is also made to be an integral multiple of the nozzle pitch. Therefore, the movement distance in the secondary scan can be set to an integral multiple of the nozzle pitch when the nozzle row moves in a region in which the liquid has not been deposited between the nozzle rows after the discharge scan, whereby the discharge nozzles can be made to efficiently face, without excess or insufficiency, the region in which the liquid has not been deposited between the nozzle rows.

The apparatus for manufacturing an electro-optical device as described above preferably further includes a nozzle row spacing adjustment section configured and arranged to adjust a spacing between a plurality of the nozzle rows in the array direction.

According to this apparatus for manufacturing an electro-optical device, a manufacturing device having suitable spacing between nozzle rows can be configured in correspondence with the shape of the substrate and the manufacturing method by adjusting the spacing between the nozzle rows using nozzle row spacing adjustment section.

### BRIEF DESCRIPTION OF THE DRAWINGS

Referring now to the attached drawings which form a part of this original disclosure:

FIG. 1 is a perspective view of the external appearance showing the general configuration of the droplet discharge device;

FIG. 2A is a perspective view of the external appearance of the droplet discharge head as viewed from the nozzle plate side, FIG. 2B is a perspective cross-sectional view showing the structure around the pressure chamber of the droplet discharge head, and FIG. 2C is a cross-sectional view showing the structure of the discharge nozzle section of the droplet discharge head;

FIG. 3 is a plan view showing the general configuration of the head unit;

FIG. 4 is an electrical configuration block diagram showing the electrical configuration of the droplet discharge device;

FIG. 5 is a descriptive view showing the flow of signals and the electrical configuration of the droplet discharge head;

FIG. 6A is a view showing the fundamental waveform of the drive waveform of the drive signal applied to the piezoelectric element, and FIG. 6B is a schematic cross-sectional view showing the discharge operation of the droplet discharge head carried out by the piezoelectric element that corresponds to the drive waveform;

FIG. 7(a) is a descriptive view showing the arrangement positions of the discharge nozzles, FIG. 7(b) is a descriptive view showing the state in which droplets have landed in a rectilinear shape in the direction in which the nozzle rows extend, FIG. 7(c) is a descriptive view showing the state of droplets landed in a rectilinear shape in the main scanning direction, and FIG. 7(d) is a descriptive view showing a state in which droplets have landed in a planar shape;

FIG. 8 is an exploded perspective view showing the general configuration of a liquid crystal display panel;

FIG. 9A is a plan view schematically showing the planar structure of an opposing substrate, and FIG. 9B is a plan view schematically showing the planar structure of a mother opposing substrate;

FIG. 10 is a schematic plan view showing an example of an arrangement of filter films of a tricolored color filter;

FIG. 11 is a flowchart that shows the process for forming a liquid crystal display panel;

FIG. 12 is a cross-sectional view showing the steps for forming a filter film in the process for forming a liquid crystal display panel;

FIG. 13 is a cross-sectional view showing the steps for forming an alignment film in the process for forming a liquid crystal display panel;

FIG. 14 is a descriptive view showing the relationship between the filter film region and the discharge nozzles that perform a discharge in the step for depositing the functional liquid;

FIG. 15 is a descriptive view showing the relationship between the CF layer region and the droplet discharge head that performs discharges in the step for depositing the functional liquid;

FIG. 16 is a schematic front view showing the plan configuration of the organic EL display device;

FIG. 17 is a plan view showing the arrangement example of the organic EL display device;

FIG. 18 is a cross-sectional view of the main parts including the organic EL elements of the organic EL display device;

FIG. 19 is a flowchart that shows the process for forming a luminescent layer and a hole-transport layer of the element substrate;

FIG. 20 is a schematic cross-sectional view showing the process for forming a luminescent layer and a hole-transport layer of the element substrate;

FIG. 21 is a descriptive view showing the relationship between the pixel region and the arrangement of the droplet discharge heads for performing discharges in the step for depositing the functional liquid; and

FIG. 22 is a descriptive view showing the relationship between the display region and the arrangement of the droplet discharge head for performing discharges in the step for depositing the luminescent layer material liquid.

### DETAILED DESCRIPTION OF EXEMPLARY EMBODIMENTS

Preferred embodiments of the method for manufacturing an electro-optical device, and the apparatus for manufacturing an electro-optical device are described below with reference to the accompanying drawings. The embodiments will be described using as an example a method for manufacturing a color filter film and a luminescent layer or another functional film in a step for manufacturing a color filter substrate of a liquid crystal display panel constituting a liquid crystal device as an example of an electro-optical device, and a step for manufacturing an organic EL display device as an example of an electro-optical device. In the step for manufacturing the functional film, an example will be described using a method for depositing a functional liquid containing a functional film material in predetermined partitions on a substrate using a droplet discharge device having an inkjet-type droplet discharge head as an example of a discharge head provided with a nozzle row. For the sake of convenience in the drawings referred to in the description below, there are cases in which the lengthwise and crosswise scaling of members or portions are different from actual members or portions.

### First Embodiment

Described first is a first embodiment as an embodiment of the method for manufacturing an electro-optical device, and an apparatus for manufacturing an electro-optical device. The present embodiment will be described using a manufacturing method and a manufacturing device as an example in which a step is used for forming a color element film (filter film), which is an example of a functional film, in the step for manufacturing a color filter of a liquid crystal display device, which is an example of an electro-optical device.

### Droplet Discharge Method

The droplet discharge method used in the formation of a filter film or another functional film will be described first. The droplet discharge method has an advantage in that a desired amount of material can be deposited with good accuracy in a desired position without wasteful usage of the material. Examples of the discharge technique of the droplet discharge method include an electrification control scheme, a pressurized vibration scheme, an electromechanical conversion scheme, an electrothermal conversion scheme, and an electrostatic attraction scheme.

Among these, an electromechanical conversion scheme makes use of the property in which a piezoelement (piezoelectric element) receives a pulse-like electric signal and deforms. The deformation of the piezoelement applies pressure via a member formed from a material having flexibility in a space in which the liquid containing a material is stored, and the liquid is pushed from the space and discharged from the discharge nozzle. The piezo scheme substantially does not heat the liquid and therefore has an advantage in that the size of the composition of the material is not substantially affected by heat. There is also an advantage in that an accurate discharge quantity can be achieved because the size of the droplets can be readily adjusted by adjusting the drive voltage or other drive conditions. In the present embodiment, since the composition or the like of the material is not affected, the degree of freedom in selecting the liquid material is high and the size of the droplets can be readily adjusted. Therefore, the piezo scheme is used because the controllability of the droplets is good.

### Droplet Discharge Device

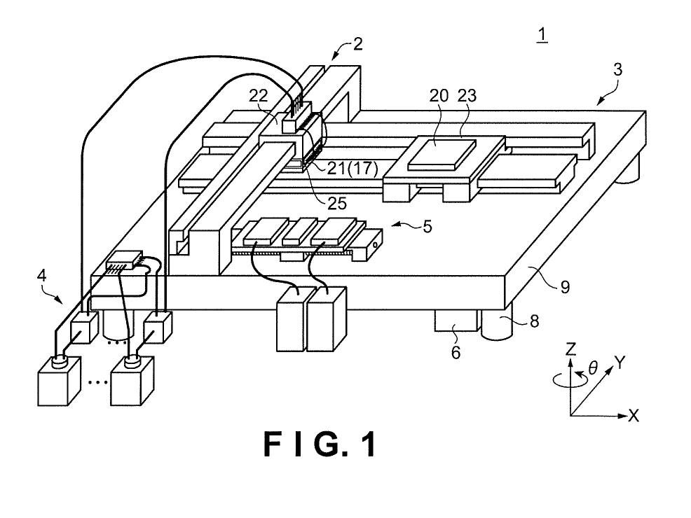

Next, the overall configuration of the droplet discharge device 1 provided with a droplet discharge head 17 will be described with reference to FIG. 1. FIG. 1 is a perspective view of the external appearance showing the general configuration of the droplet discharge device.

The droplet discharge device 1 is provided with a head mechanism section 2, a workpiece mechanism section 3, a functional liquid feed section 4, and a maintenance device section 5, as shown in FIG. 1. The head mechanism section 2 has a droplet discharge head 17 for discharging as droplets a functional liquid acting as the liquid. The workpiece mechanism section 3 has a workpiece stage 23 for mounting a workpiece 20 as the discharge target of the droplets discharged from the droplet discharge head 17. The functional liquid feed section 4 has a relay tank and liquid feed tube. The liquid feed tube is connected to the droplet discharge head 17, and functional liquid is fed to the droplet discharge head 17 via the liquid feed tube. The maintenance device section 5 is provided with devices for carrying out inspection and maintenance of the droplet discharge head 17. The droplet discharge device 1 is provided with a discharge device control section 6 for providing overall control of these mechanisms and the like.

The droplet discharge device 1 is provided with a plurality of support legs 8 disposed on the floor, and a surface plate 9 disposed on the obverse side of the support legs 8. The workpiece mechanism section 3 is disposed on the obverse side of the surface plate 9 so as to extend in the lengthwise direction (X-axis direction) of the surface plate 9. The head mechanism section 2 supported by two support columns secured to the surface plate 9 is disposed above the workpiece mechanism section 3 so as to extend in the direction orthogonal (Y-axis direction) to the workpiece mechanism section 3. A functional liquid tank or the like of the functional liquid feed section 4, which has a feed tube that is in communication with the droplet discharge head 17 of the head mechanism section 2, is disposed to the side of the surface plate 9. The maintenance device section 5 is disposed in the vicinity of one of the support columns of the head mechanism section 2 in the X-axis direction in alignment with the workpiece mechanism section 3. The discharge device control section 6 is furthermore accommodated below the surface plate 9.

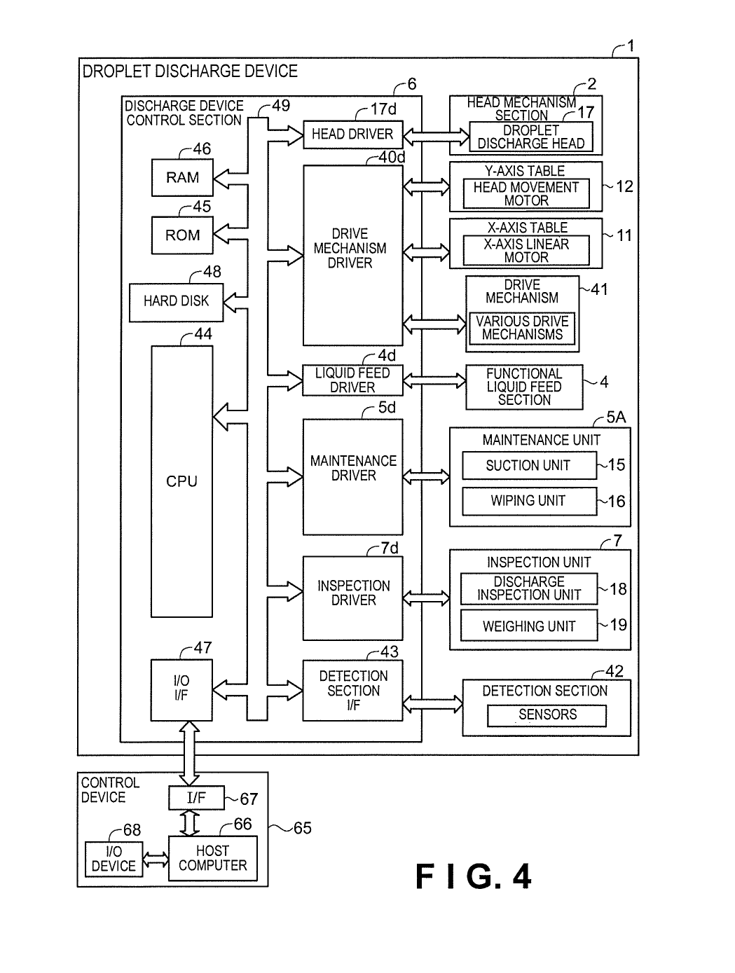

The head mechanism section 2 is provided with a head unit 21 having the droplet discharge head 17, a head carriage 25 having the head unit 21, and a movement frame 22 from which the head carriage 25 is suspended. The droplet discharge head 17 is freely moved in the Y-axis direction by moving the movement frame 22 in the Y-axis direction using a Y-axis table 12 (see FIG. 4), and is held in the moved position. The workpiece mechanism section 3 can freely move the workpiece stage 23 in the X-axis direction using an X-axis table 11 (see FIG. 4), whereby the workpiece 20 mounted on the workpiece stage 23 is moved in the X-axis direction, and is held in the moved position.

In this manner, the droplet discharge head 17 moves to the discharge position in the Y-axis direction and stops, and the functional liquid is discharged as droplets in synchronization with the movement of the workpiece 20 below in the X-axis direction. Droplets can be made to land in any position on the workpiece 20 by controlling the relative movement of the workpiece 20 that moves in the X-axis direction and the droplet discharge head 17 that moves in the Y-axis direction, whereby desired plane-shaped drawing can be carried out.

### Droplet Discharge Head

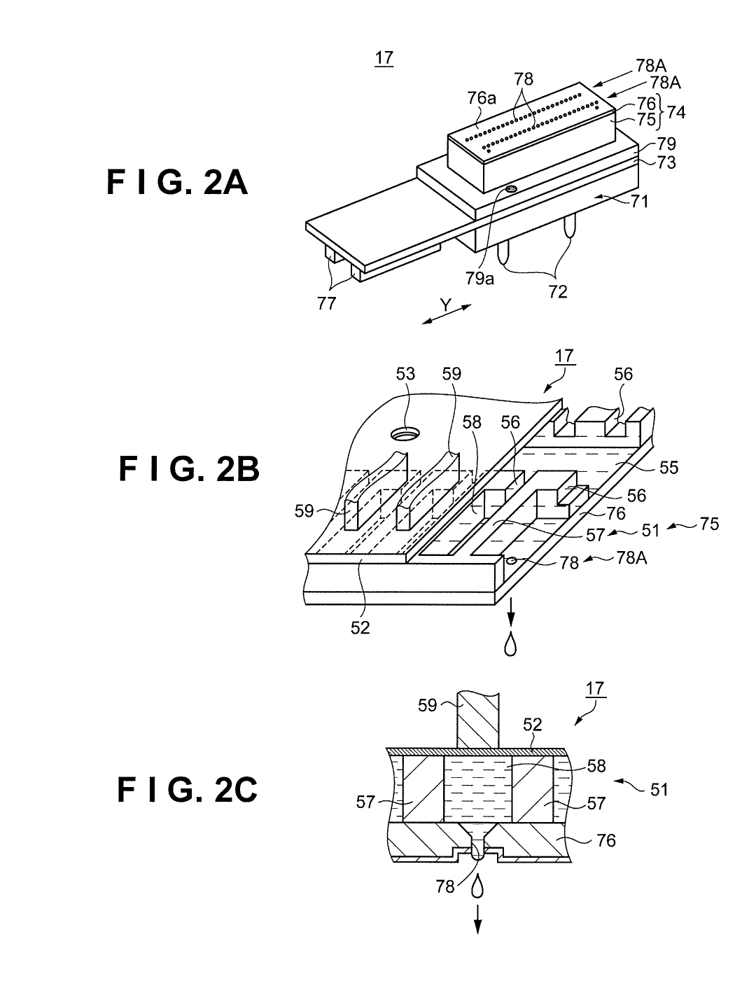

Next, the droplet discharge head 17 will be described with reference to FIG. 2. FIG. 2 is a view showing the configuration of the droplet discharge head. FIG. 2A is a perspective view of the external appearance of the droplet discharge head as viewed from the nozzle plate side, FIG. 2B is a perspective cross-sectional view showing the structure around the pressure chamber of the droplet discharge head, and FIG. 2C is a cross-sectional view showing the structure of the discharge nozzle section of the droplet discharge head.

The droplet discharge head 17 is a so-called two-row head, and is provided with a liquid introduction section 71 having two connection needles 72, 72, as well as a head substrate 73 extended lateral to the liquid introduction section 71, a pump section 75 extending to the liquid introduction section 71, and a nozzle plate 76 extending to the pump section 75, as shown in FIG. 2A. A tube connection member is connected to each of the connection needles 72 of the liquid introduction section 71, the liquid feed tube is connected via the tube connection member, and functional liquid is fed from the functional liquid feed section 4 connected to the liquid feed tube. A pair of head connectors 77, 77 is mounted on the head substrate 73, and a flexible flat cable (FFC cable) is connected via the head connector 77. The droplet discharge head 17 is connected to the discharge device control section 6 via the FFC cable, and signals are transceived via the FFC cable. A substantially quadrangular head main body 74 is composed of the pump section 75 and the nozzle plate 76.

The base section side of the pump section 75, i.e., the base section side of the head main body 74 has a flange section 79 formed in the shape of a quadrangular flange for seating the liquid introduction section 71 and the head substrate 73. A pair of screw holes (female thread) 79a for small screws for securing the droplet discharge head 17 is formed in the flange section 79. The droplet discharge head 17 is secured to a head-holding member by head setscrews threaded into the screw holes 79a through the head-holding member for holding the droplet discharge head 17.

Two nozzle rows 78A composed of the discharge nozzles 78 formed in the nozzle plate 76 and used for discharging droplets are formed on a nozzle formation surface 76a of the nozzle plate 76. The two nozzle rows 78A are arranged parallel to each other, and each of the nozzle rows 78A is composed of, e.g., 180 (shown schematically in the drawings) discharge nozzles 78 aligned at an equal pitch. In other words, two nozzle rows 78A are arranged on the two sides of the centerline in the nozzle formation surface 76a of the head main body 74.

The nozzle rows 78A extend in the Y-axis direction when the droplet discharge head 17 has been mounted on the droplet discharge device 1. The discharge nozzles 78 constituting the two nozzle rows 78A are positionally offset by half a nozzle pitch from each other in the Y-axis direction. A single nozzle pitch is, e.g., 140 μm. Droplets discharged from the discharge nozzles 78 constituting each of the nozzle rows 78A are designed to land in the same position in the X-axis direction in a rectilinear fashion in alignment with the Y-axis direction at equidistant intervals. In the case that the nozzle pitch of the discharge nozzles 78 in the nozzle rows 78A is 140 μm, the center distance of the landing positions extending in the stated rectilinear fashion is designed to be 70 μm. The two nozzle rows 78A of a single droplet discharge head 17 can be considered to be a single nozzle row. The nozzle rows are referred to as “head nozzle rows.” The head nozzle row has, e.g., 2×180, i.e., 360 discharge nozzles 78, the nozzle pitch in the Y-axis direction is 70 μm, and the center distance (nozzle row length) of the discharge nozzles 78 at the two ends in the Y-axis direction is about 25.1 mm.

The droplet discharge head 17 has a pressure chamber plate 51 that constitutes the pump section 75 and is layered on the nozzle plate 76, and has a vibration plate 52 layered on the pressure chamber plate 51, as shown in FIGS. 2B and 2C.

A liquid reservoir 55 constantly filled with functional liquid fed from the liquid introduction section 71 via a liquid feed hole 53 of the vibration plate 52 is foamed in the pressure chamber plate 51. The liquid reservoir 55 is a space enclosed by the vibration plate 52, the nozzle plate 76, and the walls of the pressure chamber plate 51. A pressure chamber 58 partitioned by a plurality of head partition walls 57 is formed in the pressure chamber plate 51. The space enclosed by the vibration plate 52, the nozzle plate 76, and two head partition walls 57 is the pressure chamber 58.

The pressure chambers 58 are provided correspondingly with respect to each of the discharge nozzles 78, so that the number of pressure chambers 58 and the number of discharge nozzles 78 are the same. Functional liquid from the liquid reservoir 55 is fed to the pressure chamber 58 via a feed port 56 positioned between the two head partition walls 57. Groups comprising the head partition walls 57, the pressures chamber 58, the discharge nozzles 78, and the feed ports 56 are aligned in a single row along the liquid reservoir 55, and the discharge nozzles 78 aligned in a single row form a nozzle row 78A. Although not shown in FIG. 2B, discharge nozzles 78 arranged in a single row form another nozzle row 78A in a substantially symmetrical position in relation to the liquid reservoir 55, and groups comprising the corresponding head partition walls 57, pressure chambers 58, and feed ports 56 are aligned in a single row with respect to the nozzle rows 78A that includes the depicted discharge nozzles 78.

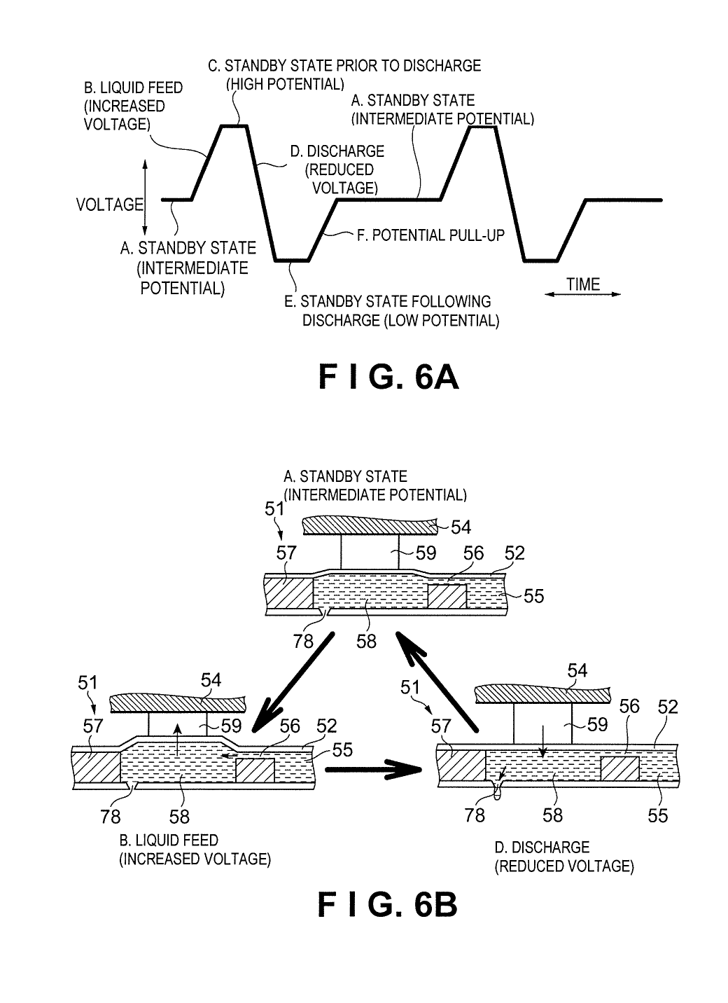

One end of piezoelectric elements 59 is secured to each of the portions constituting the pressure chamber 58 of the vibration plate 52. The other end of the piezoelectric elements 59 is secured to a base (not shown) for supporting the entire droplet discharge head 17 via a fixed plate 54 (see FIG. 6B).

The piezoelectric elements 59 have active sections obtained by layering an electrode layer and a piezoelectric material, and the active sections contract in the lengthwise direction (the thickness direction of the vibration plate 52 in FIG. 2B or 2(c)) when a drive voltage is applied to the electrode layer. When the active sections contract, there is received a force that pulls the vibration plate 52 secured to one end of the piezoelectric elements 59 to the opposite side of the pressure chamber 58. The vibration plate 52 is pulled toward the opposite side of the pressure chamber 58, whereby the vibration plate 52 flexes toward the opposite side of the pressure chamber 58. Since the volume of the pressure chamber 58 is thereby increased, the functional liquid is fed from the liquid reservoir 55 to the pressure chamber 58 via the feed port 56. Next, when the drive voltage applied to the electrode layer is discontinued, the active section returns to the original length, whereby the piezoelectric element 59 presses the vibration plate 52. The vibration plate 52 is pressed and made to return to the pressure chamber 58 side. The volume of the pressure chamber 58 thereby rapidly returns to the original state; i.e., the increased volume is reduced. Therefore, pressure is applied to the functional liquid present in the pressure chamber 58, and the functional liquid is discharged as a droplet from the nozzle 78 formed in communication with the pressure chamber 58.

The discharge device control section 6 controls the discharge of functional liquid from a plurality of the discharge nozzles 78 by controlling the voltage applied to the piezoelectric elements 59, i.e., controlling the drive signals. More specifically, the volume of the droplets discharged from the discharge nozzles 78, the number of droplets discharged per unit of time, and other factors can be varied. Therefore, the distance between the droplets that have landed on the substrate, the amount of functional liquid that has been made to land in a fixed surface area on the substrate, and other factors can be varied. For example, a plurality of droplets can be simultaneously discharged at the pitch interval of the discharge nozzles 78 in a range of the length of the nozzle rows 78A in the direction in which the nozzle rows 78A extend by selectively using the discharge nozzles 78 for discharging droplets from among the plurality of discharge nozzles 78 aligned in the nozzle rows 78A. In the direction substantially orthogonal to the direction in which the nozzle rows 78A extend, the substrate and the discharge nozzles 78 are moved in a relative fashion and droplets discharged from the discharge nozzles 78 can be deposited in any position in the directions of relative movement on the substrate that the discharge nozzles 78 are capable of facing. The volume of the droplets discharged from the discharge nozzles 78 is variable between, e.g., 1 pL to 300 pL (picoliter).

### Head Unit

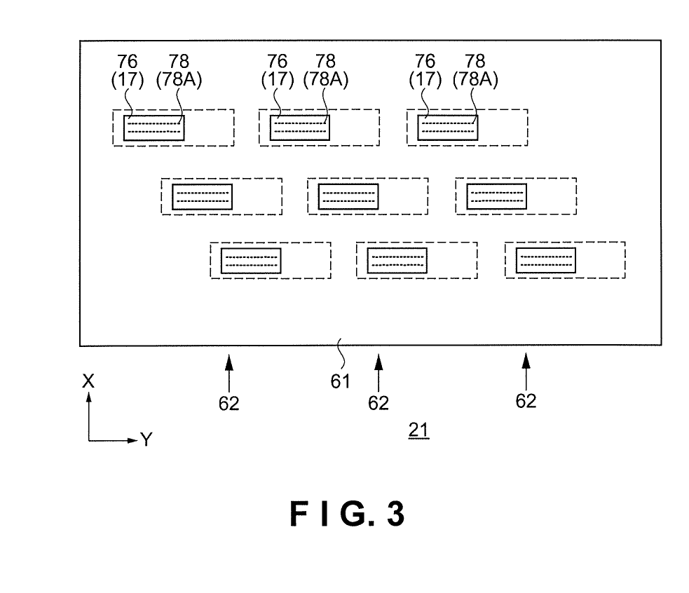

Next, the general configuration of the head unit 21 will be described with reference to FIG. 3. FIG. 3 is a plan view showing the general configuration of the head unit. The X-axis and Y-axis shown in FIG. 3 match the X-axis and Y-axis shown in FIG. 1 in a state in which the head unit 21 is mounted on the droplet discharge device 1.

The head unit 21 has a carriage plate 61, and nine droplet discharge heads 17 mounted on the carriage plate 61, as shown in FIG. 3. The droplet discharge head 17 is secured to the carriage plate 61 via a head-holding member (not shown). The droplet discharge head 17 thus secured is configured so that the head main body 74 is loosely fitted into a hole (not shown) formed in the carriage plate 61, and the nozzle plate 76 (head main body 74) protrudes from the surface of the carriage plate 61. FIG. 3 is a view as seen from the nozzle plate 76 (nozzle formation surface 76a) side. The nine droplet discharge heads 17 are formed into three head assemblies 62 having three droplet discharge heads 17 each separated in the Y-axis direction. The nozzle rows 78A of the droplet discharge head 17 extend in the Y-axis direction in a state in which the head unit 21 is mounted on the droplet discharge device 1.

The three droplet discharge heads 17 of one of the head assemblies 62 are arranged in positions in which the discharge nozzles 78 at the end of one of the droplet discharge heads 17 are offset by a half nozzle pitch with respect to the discharge nozzles 78 at the end of the other droplet discharge head 17 among the droplet discharge heads 17 mutually adjacent in the Y-axis direction. When the positions in the X-axis direction of all the discharge nozzles 78 are the same in the three droplet discharge heads 17 of the head assembly 62, the discharge nozzles 78 are aligned at equidistant intervals of the half nozzle pitch in the Y-axis direction. In other words, the droplets discharged in the same positions in the X-axis direction from the discharge nozzles 78 constituting the nozzle rows 78A of the droplet discharge heads 17 are designed to land in a rectilinear fashion in alignment with the Y-axis direction at equidistant intervals. The six nozzle rows 78A of the three droplet discharge head 17 provided to a single head assembly 62 can be considered to be a single nozzle row. Such a nozzle row is referred to as a “head assembly nozzle row.” The head assembly nozzle row has, e.g., 6×180=1080 discharge nozzles 78, the nozzle pitch in the Y-axis direction is 70 μm, and the center distance (nozzle row length) of the discharge nozzles 78 at the two ends in the Y-axis direction is about 75.5 mm. The head assembly 62 is configured so as to be aligned in a stepwise fashion in the X-axis direction because the droplet discharge heads 17 mutually overlap in the Y-axis direction.

The three head assemblies 62 of the head unit 21 are arranged in positions in which a single head assembly nozzle row of each head assembly 62 is positioned offset by a half nozzle pitch of the nozzle rows 78A in the Y-axis direction. In other words, each of the head units 21 is arranged in a position in which the discharge nozzles 78 at the ends of the droplet discharge head 17 in one head assembly 62 are offset by half a nozzle pitch in the Y-axis direction in relation to the discharge nozzles 78 at the ends of the droplet discharge head 17 in another head assembly 62, in the droplet discharge heads 17 constituting mutually adjacent head assemblies 62.

The 18 nozzle rows 78A of the nine droplet discharge heads 17 of the three head assemblies 62 of a single head unit 21 can be considered to be a single nozzle row. Such a nozzle row is referred to as a “unit nozzle row.” A unit nozzle row has, e.g., 18×180=3240 discharge nozzles 78, the nozzle pitch in the Y-axis direction is 70 μm, and the center distance (nozzle row length) of the discharge nozzles 78 at the two ends in the Y-axis direction is about 226.7 mm. In other words, when droplets are discharged one at a time from the discharge nozzles 78 of a single head unit 21 and made to land in the same position in the X-axis direction, 3240 points are connected at a pitch interval of 70 μm to form a straight line.

### Electrical Configuration of Droplet Discharge Device

Next, the electrical configuration for driving a droplet discharge device 1 having a configuration such as that described above will be described with reference to FIG. 4. FIG. 4 is an electrical configuration block diagram showing the electrical configuration of the droplet discharge device. The droplet discharge device 1 is controlled by the input of data, as well as operation start, stop, and other command instructions via a control device 65. The control device 65 has a host computer 66 for performing computational processes, and an I/O device 68 for inputting and outputting information to the droplet discharge device 1, and is connected to the discharge device control section 6 via an interface (I/F) 67. The I/O device 68 is a keyboard that can input information, an external I/O device for inputting and outputting information via a recording medium, a recording section for saving information inputted via the external I/O device, a monitor device, or the like.

The discharge device control section 6 of the droplet discharge device 1 has an I/O interface (I/F) 47, a CPU (central processing unit) 44, a ROM (read only memory) 45, a RAM (random access memory) 46, and a hard disk drive 48. Also provided are a head driver 17d, a drive mechanism driver 40d, a liquid feed driver 4d, a maintenance driver 5d, an inspection driver 7d, and a detection section interface (I/F) 43. These components are electrically connected to each other via a data bus 49.

The I/O interface 47 performs data transfers with the control device 65. The CPU 44 performs various computational processes on the basis of commands from the control device 65 and outputs control signals for controlling the operation of each section of the droplet discharge device 1. The RAM 46 temporarily stores print data and control commands received from the control device 65 in accordance with commands from the CPU 44. The ROM 45 stores routines or the like that are used by the CPU 44 to perform various computational processes. The hard disk drive 48 stores print data and control commands received from the control device 65, and stores routines or the like that are used by the CPU 44 to perform various computational processes.

A droplet discharge head 17 constituting the head mechanism section 2 is connected to the head driver 17d. The head driver 17d drives the droplet discharge head 17 and causes droplets of the functional liquid to be discharged in accordance with control signals from the CPU 44. Connected to the drive mechanism driver 40d are: a head movement motor of a Y-axis table 12, an X-axis linear motor of an X-axis table 11, and a drive mechanism 41 that includes various drive mechanisms having various drive sources. The various drive mechanisms include a camera movement motor for moving an alignment camera, a θ drive motor of the workpiece stage 23, and other drive motors. The drive mechanism driver 40d drives the above-described motors or the like in accordance with control signals from the CPU 44, causes the droplet discharge head 17 and the workpiece 20 to move in a relative fashion, causes the droplet discharge head 17 to face an arbitrary position of the workpiece 20, and causes a droplet of the functional liquid to land in an arbitrary position on the workpiece 20 in cooperation with the head driver 17d.

Connected to the maintenance driver 5d are a wiping unit 16, and a suction unit 15 of a maintenance unit 5A constituting the maintenance device section 105. The maintenance driver 5d drives the suction unit 15 or the wiping unit 16 in accordance with control signals from the CPU 44, and carries out maintenance operations for the droplet discharge head 17.

Connected to the inspection driver 7d are a weighing unit 19, and a discharge inspection unit 18 of an inspection unit 7, as well as other units. The inspection driver 7d drives the discharge inspection unit 18 in accordance with control signals from the CPU 44, and inspects the presence of a discharge, landing position accuracy, and other discharge states of the droplet discharge head 17. The inspection driver 7d also drives the weighing unit 19 and weighs the discharge as the weight of the droplet of liquid discharged from the droplet discharge head 17. The discharge weight in the present embodiment is the weight of a single droplet of the functional liquid discharged by the discharge nozzles 78 of the droplet discharge head 17. The size (volume) of a single droplet of the functional liquid discharged by the discharge nozzles 78 of the droplet discharge head 17 is referred as the discharge amount. The discharge weight and the discharge amount each refer to the same quantity in terms of weight or volume.

The functional liquid feed section 4 is connected to the liquid feed driver 4d. The liquid feed driver 4d drives the functional liquid feed section 4 in accordance with control signals from the CPU 44 and feeds functional liquid to the droplet discharge head 17. A detection section 42 that includes various sensors is connected to the detection section interface 43. The detection information detected by the sensors of the detection section 42 is transmitted to the CPU 44 via the detection section interface 43.

### Discharge of Functional Liquid

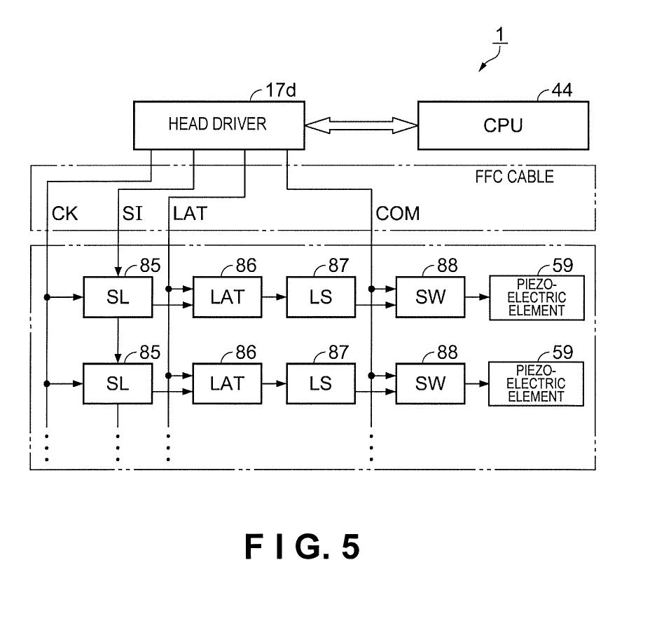

Next, the method for controlling discharge in the droplet discharge device 1 will be described with reference to FIG. 5. FIG. 5 is a descriptive view showing the electrical configuration of the droplet discharge head and the flow of signals

As described above, the droplet discharge device 1 is provided with a CPU 44 for outputting control signals that control the operation of the each part of the droplet discharge device 1, and a head driver 17d for providing electrical drive control of the droplet discharge head 17.

The head driver 17d is electrically connected to each droplet discharge head 17 via an FFC cable, as shown in FIG. 5. The droplet discharge head 17 is provided with a shift register (SL) 85, a latch circuit (LAT) 86, a level shifter (LS) 87, and a switch (SW) 88, in correspondence with the piezoelectric element 59 provided to each discharge nozzle 78 (see FIG. 2).

Discharge control in the droplet discharge device 1 is carried out in the following manner. First, the CPU 44 transfers to the head driver 17d dot pattern data in which a pattern in which the functional liquid is deposited on the workpiece 20 or another drawing target has been formed into data. The head driver 17d decodes the dot pattern data and generates nozzle data, which is the ON/OFF (discharge/non-discharge) information of the discharge nozzles 78. The nozzle data is converted to a serial signal (SI), synchronized with the clock signal (CK), and transmitted to the shift registers 85.

The nozzle data transmitted to the shift registers 85 is latched at timing in which the latch signal (LAT) is inputted to the latch circuit 86, and is converted by the level shifter 87 to a gate signal for the switch 88. In other words, the switch 88 is opened when nozzle data indicates “ON,” and a drive signal (COM) is fed to the piezoelectric elements 59. The switch 88 is closed when nozzle data indicates “OFF,” and a drive signal (COM) is not fed to the piezoelectric elements 59. Functional liquid is discharged as droplets from the discharge nozzles 78 that correspond to “ON,” the discharged droplets of functional liquid land on the workpiece 20 or another drawing target, and the functional liquid is deposited on the drawing target.

The timing for inputting the latch signal (LAT) to the latch circuit 86 is shared for each nozzle row 78A in the droplet discharge head 17, for example, and functional liquid is discharged as droplets at substantially the same time from the discharge nozzles 78 constituting the nozzle rows 78A.

### Drive Waveform

Described next with reference to FIG. 6 is the discharge operation of the piezoelectric elements 59 to which are applied a drive waveform of the drive signal (COM) applied to the piezoelectric elements 59 and a drive signal of the drive waveform. FIG. 6 is a diagram showing the operation of the piezoelectric elements that correspond to the drive waveform and the fundamental waveform of the drive waveform. FIG. 6A is a diagram showing the fundamental waveform of the drive waveform of the drive signal applied to the piezoelectric element; and FIG. 6B is a schematic cross-sectional view showing the discharge operation of the droplet discharge head carried out by the piezoelectric element that corresponds to the drive waveform.

A constant voltage is applied (A of FIG. 6A) to the piezoelectric element 59 in the standby state prior to the application of a drive signal, as shown in FIG. 6A. This voltage will be referred to as an intermediate potential. The voltage applied to the piezoelectric element 59 is raised to the intermediate potential prior to the start of drawing when drawing is to be carried out, and is returned to a ground level after drawing has been carried out.

The piezoelectric element 59 slightly contracts and the vibration plate 52 is pulled toward the piezoelectric element 59 in a state in which the piezoelectric element 59 has been kept at the intermediate potential, whereby the vibration plate 52 flexes (A of FIG. 6B) toward to the opposite side of the pressure chamber 58, as shown in FIG. 6B.

In the first step of the drive cycle, the voltage applied to the piezoelectric element 59 begins from the intermediate potential and is raised to a high potential (voltage increase, B or FIG. 6A). The voltage applied to the piezoelectric element 59 increases, whereby the piezoelectric element 59 contracts further and the vibration plate 52 receives a force that pulls toward the opposite side of the pressure chamber 58. When the vibration plate 52 is pulled toward the opposite side of the pressure chamber 58, the vibration plate 52, being formed from a flexible material, flexes toward the opposite side of the pressure chamber 58. Functional liquid is thereby fed from the liquid reservoir 55 to the pressure chamber 58 via the feed ports 56 ((liquid feed), B of FIG. 6B) because the volume of the pressure chamber 58 has been increased.

This step will be referred to as the voltage increase/liquid feed step. In the voltage increase/liquid feed step, the piezoelectric element 59 is made to slowly displace so that air does not enter from the discharge nozzles 78 into the pressure chamber. The voltage of the high potential applied to the piezoelectric element 59 corresponds to the drive voltage applied for driving the droplet discharge head 17.

High-potential voltage applied to the piezoelectric element 59 that corresponds to an individual discharge nozzle 78 corresponds the drive voltage of the discharge nozzle 78, and the conditions of the drive waveform and the like applied to the piezoelectric element 59 including the drive voltage are referred to as the discharge drive conditions of the discharge nozzles 78. The CPU 44 for outputting control signals that control the drive voltage corresponds to drive conditions setting section.

As described above, droplets of the functional liquid are discharged at substantially the same time from the discharge nozzles 78 constituting the nozzle rows 78A. Therefore, the timing at which the vibration plate 52 is pulled toward the opposite side of the pressure chamber 58 is also substantially the same timing in all the discharge nozzles 78 constituting the nozzle rows 78A. The vibration plate 52 forming the pressure chamber 58 is shared by all the discharge nozzles 78 constituting the nozzle rows 78A. Accordingly, a slight fluctuation is possible in the flexing shape and flexing distance of the portions that form the pressure chambers 58 of the vibration plate 52 toward the opposite side of the pressure chamber 58, depending on whether adjacent nozzle rows 78A or the nozzle rows 78A in proximal positions are to carry out the discharge. In other words, there is a possibility that the discharge amount from the discharge nozzles 78 will slightly fluctuate.

After the voltage increase/liquid feed step, the voltage applied to the piezoelectric element 59 is kept at a high potential. This state will be referred to as the standby state prior to discharge (C of FIG. 6A). The piezoelectric material constituting the piezoelectric element 59 undergoes residual mechanical vibrations even after the change in voltage has ended. Therefore, the step for waiting until the mechanical vibrations to subside is the standby state prior to discharge.

After the standby state prior to discharge has been maintained for a time commensurate with the subsiding of the mechanical vibrations, the voltage applied to the piezoelectric element 59 is reduced in a single operation (D of FIG. 6A). The displacement of the piezoelectric element 59 is set to zero in a single operation by reducing the voltage applied to the piezoelectric element 59 in a single operation. The pressure chamber 58 rapidly narrows and the functional liquid introduced into the pressure chamber 58 is discharged from the discharge nozzles 78 (D of FIG. 6B). This step will be referred to as the voltage reduction/discharge step.

The amount by which the volume of the pressure chamber 58 increases differs because the distance that the piezoelectric element 59 contracts differs depending on the high potential voltage to be applied because the amount of displacement of the piezoelectric element 59 varies depending on the voltage to be applied. Accordingly, the amount of functional liquid held in and discharged from the pressure chamber 58, i.e., the amount of discharge from the discharge nozzles 78 of the droplet discharge head 17 can be adjusted by adjusting the high-potential voltage.

As described above, the droplets of functional liquid are designed to be simultaneously discharged from the discharge nozzles 78 constituting the nozzle rows 78A. Therefore, the timing at which voltage applied to the piezoelectric element 59 is increased to a high potential is also substantially the same timing in the discharge nozzles 78 constituting the nozzle rows 78A. Accordingly, there is a possibility that the high potential voltage applied to the piezoelectric elements 59 will fluctuate, albeit slightly, depending on the number of discharge nozzles 78 used for carrying out the discharge from the nozzle rows 78A. In other words, there is a possibility that the discharge amount from the discharge nozzles 78 will slightly fluctuate.

Following the voltage reduction/discharge step, the state in which the voltage applied to the piezoelectric element 59 is kept in a state of low potential. This state will be referred to as the standby state following discharge (E of FIG. 6A). The step for maintaining the low potential state for a time commensurate with the subsiding of the mechanical vibrations is the standby state following discharge.

After the standby state following discharge has been maintained for a time commensurate with the subsiding of the mechanical vibrations of the piezoelectric element 59, the voltage applied to the piezoelectric element 59 is increased to the intermediate potential (F of FIG. 6A), thereby restoring the standby state (intermediate potential).

### Landing Positions

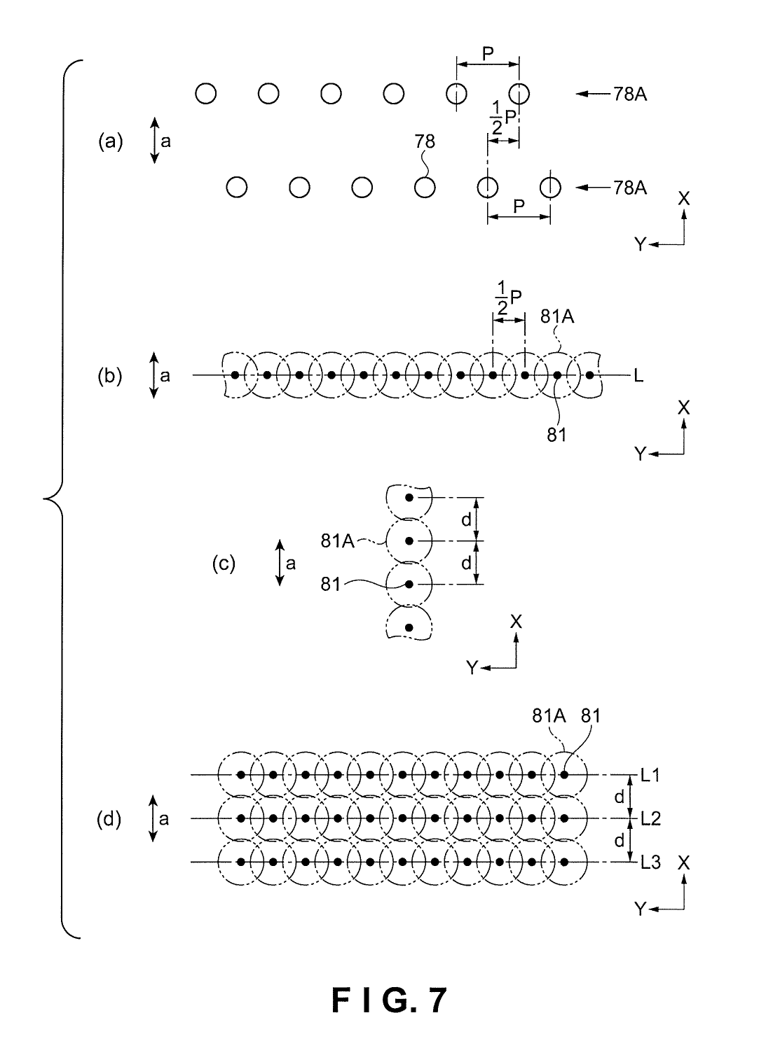

Described next is the relationship between the discharge nozzles 78 and the landing positions of the droplets discharged from the discharge nozzles 78. FIG. 7 is a descriptive view showing the relationship between the discharge nozzles and the landing positions of the droplets discharged from the discharge nozzles. FIG. 7(a) is a descriptive view showing the arrangement positions of the discharge nozzles. FIG. 7(b) is a descriptive view showing the state in which droplets have landed in a rectilinear shape in the direction in which the nozzle rows extend. FIG. 7(c) is a descriptive view showing the state of droplets landed in a rectilinear shape in the main scanning direction. FIG. 7(d) is a descriptive view showing a state in which droplets have landed in a planar shape. The X- and Y-axes shown in FIG. 7 match the X- and Y-axes shown in FIG. 1 in a state in which the head unit 21 is mounted in the droplet discharge device 1. The droplets can be made to land in arbitrary positions in the X-axis direction by discharging droplets of the liquid in arbitrary positions while the discharge nozzles 78 are moved in a relative fashion with respect to the workpiece 20 in the direction of the arrow a shown in FIG. 7, wherein the X-axis direction is the main scanning direction.

The discharge nozzles 78 constituting the nozzle rows 78A are arranged at the center distance of the nozzle pitch P in the Y-axis direction, as shown in FIG. 7(a). As described above, discharge nozzles 78 constituting two nozzle rows 78A in the droplet discharge head 17 are mutually offset in position by one-half of nozzle pitch P in the Y-axis direction.

The state of a single landed droplet is shown by the landing point 81 indicating the landing position, and the landing circle 81A indicating the state in which the landed droplet has wet and spread, as shown in FIG. 7(b). A straight line that connects the landing circles 81A is formed at a center interval of one-half the nozzle pitch P by discharging droplets from all of the discharge nozzles 78 of the two nozzle rows 78A at a timing for depositing liquid on a virtual line L indicated by the alternate long and short dash line in FIG. 7(b).

The straight line connecting the landing circles 81A is formed in the X-axis direction by discharging droplets in consecutive fashion from a single discharge nozzle 78, as shown in FIG. 7(c). The smallest value of the center distance between the landing points 81 in the X-axis direction will be referred to as the minimum landing distance d. The minimum landing distance d is the sum of the relative movement speed (movement distance/movement time) in the main scanning direction and the shortest discharge interval (time) of the discharge nozzles 78.

The shortest discharge interval of the discharge nozzles 78 is the interval in which the latch signal (LAT) described above is inputted to the latch circuit 86.

A landing surface in the straight line connecting the landing circles 81A aligned in the X-axis direction is formed at center intervals of one-half the nozzle pitch P by discharging droplets with a timing in which the liquid is made to land on the imaginary lines L1, L2, L3 shown by the alternate long and short dash line, as shown in FIG. 7(d). The landing points 81 for the case in which the distance between the imaginary lines L1, L2, L3 shown in FIG. 7(d) is the minimum landing distance d are positions in which the droplets of functional liquid can be deposited by the droplet discharge device 1.

In order to draw an image by depositing droplets or to fill the liquid into a predetermined partitioned area, the landing points 81 suitable for drawing the image and filling the partition are selected as the landing points 81 in which the droplets will be deposited. Whether or not droplets are to be deposited is determined for the position of each landing points 81 shown in FIG. 7(d), whereby the arrangement table for specifying positions in which the functional liquid is to be deposited is formed. A desired image is drawn or a desired partitioned area is filled by performing discharges in accordance with the arrangement table at points in time that correspond to the corresponding discharge nozzles 78.

### Configuration of Liquid Crystal Display Panel

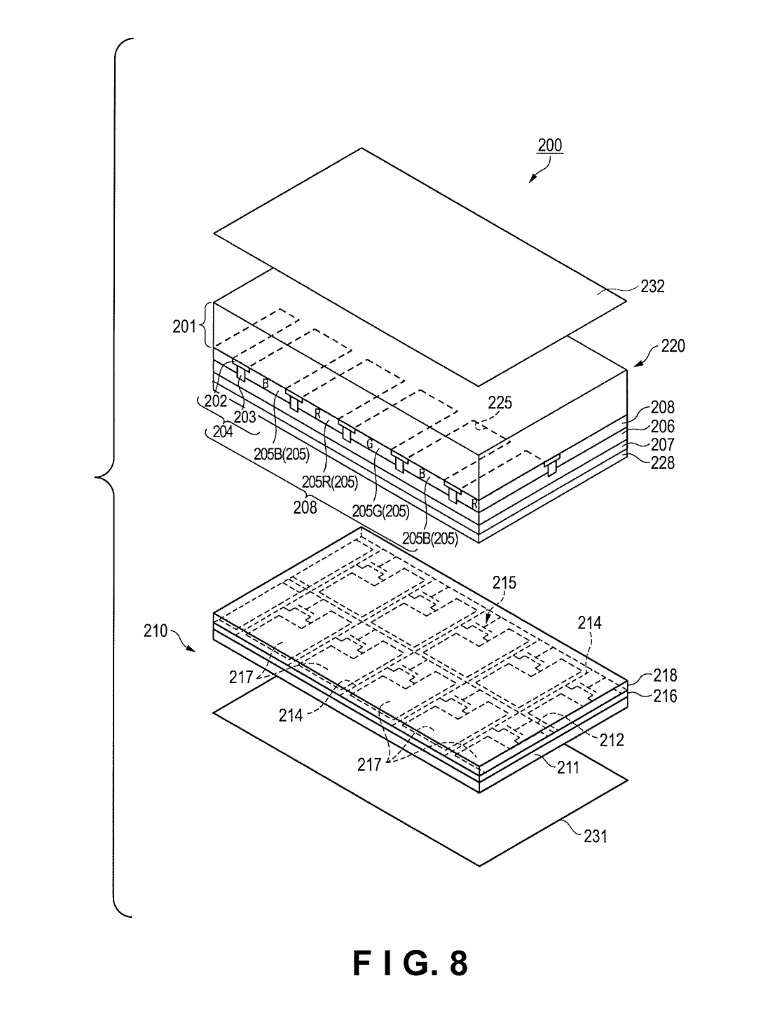

Next, a liquid crystal display panel will be described as an example of a target object for forming a functional film using the droplet discharge device 1. The liquid crystal display panel (see FIG. 8) 200 is an example of a liquid crystal device, and is a liquid crystal display panel provided with a color filter for a liquid crystal display panel as an example of a color filter.

First, the configuration of the liquid crystal display panel 200 will be described with reference to FIG. 8. FIG. 8 is an exploded perspective view showing the general configuration of a liquid crystal display panel. The liquid crystal display panel 200 shown in FIG. 8 is an active matrix-type liquid crystal device that uses thin film transistors (TFT) as the drive elements, and is a transmissive liquid crystal device that uses a backlight (not shown).

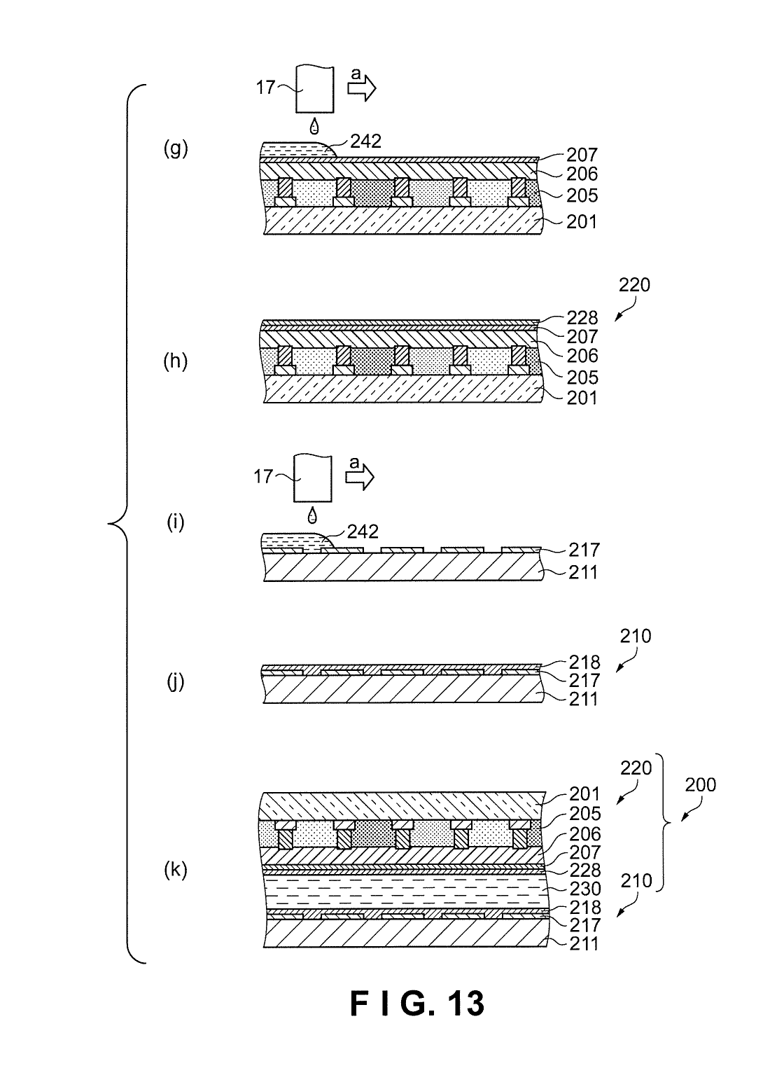

The liquid crystal display panel 200 is provided with an element substrate 210 having TFT elements 215, an opposing substrate 220 having opposing electrodes 207, and liquid crystal 230 (see FIG. 13(k)) filled between the opposing substrate 220 and the element substrate 210 bonded by a seal material (not shown), as shown in FIG. 8. A polarizing plate 231 and a polarizing plate 232 are disposed on the affixed element substrate 210 and opposing substrate 220, respectively, on the surfaces of the sides opposite from the mutually affixed surfaces.

The element substrate 210 has the TFT elements 215, electroconductive pixel electrodes 217, scan lines 212, and signal lines 214 formed on the surface that faces the opposing substrate 220 of a glass substrate 211. An insulating layer 216 is formed so as to embed the space between the elements and the electroconductive film. The scan lines 212 and the signal lines 214 are formed so as to sandwich portions of the insulating layer 216 in a mutually intersecting state. The scan lines 212 and the signal lines 214 sandwich the portions of the insulating layer 216 therebetween so as to be insulated from each other. The pixel electrodes 217 are formed in the region enclosed by the scan lines 212 and the signal lines 214. The pixel electrodes 217 have a shape in which the corner part of a quadrangular portion is quadrangularly notched. The configuration is one in which the TFT elements 215 provided with source electrodes, drain electrodes, semiconductor sections, and gate electrodes are incorporated into the portions enclosed by the scan lines 212, the signal lines 214, and the notches of the pixel electrodes 217. The TFT elements 215 are switched on and off by applying signals to the scan lines 212 and the signal lines 214 to control the energizing of the pixel electrodes 217.

An alignment film 218 that covers the entire region in which the scan lines 212, the signal lines 214, and the pixel electrodes 217 described above are formed is disposed on the surface that is in contact with the liquid crystal 230 of the element substrate 210.

The opposing substrate 220 has a color filter (hereinafter referred to as “CF”) layer 208 formed on the surface facing the element substrate 210 of a glass substrate 201. The CF layer 208 has a partition wall 204, a red filter film 205R, a green filter film 205G, and a blue filter film 205B. A black matrix 202 constituting the partition wall 204 is formed in a grid shape on the glass substrate 201, and a bank 203 is formed on the black matrix 202. A quadrangular filter film region 225 is formed by the partition wall 204 composed of the black matrix 202 and the bank 203. The red filter film 205R, the green filter film 205G, or the blue filter film 205B are formed on the filter film region 225. The red filter film 205R, the green filter film 205G, and the blue filter film 205B are formed in the shape of and the position facing the pixel electrodes 217 described above.

A flattening film 206 is disposed on the CF layer 208 (the element substrate 210 side). The opposing electrodes 207 formed from ITO or another transparent electroconductive material are disposed on the flattening film 206. The surface on which the opposing electrodes 207 are formed is made into a substantially flat surface by providing the flattening film 206. The opposing electrodes 207 are formed of a continuous film having a size sufficient for covering the entire region on which the pixel electrodes 217 described above are formed. The opposing electrodes 207 are connected to wiring formed on the element substrate 210 via a conductive part (not shown).

An alignment film 228 that covers the entire surface of at least the pixel electrodes 217 is provided to the surface in contact with the liquid crystal 230 of the opposing substrate 220. The liquid crystal 230 is filled into the space enclosed by a seal member that bonds together the alignment film 228 of the opposing substrate 220, the alignment film 218 of the element substrate 210, and the element substrate 210 of the opposing substrate 220, in a state in which the element substrate 210 and the opposing substrate 220 have been bonded together.

The liquid crystal display panel 200 has a transmissive configuration, but the liquid crystal display panel may be provided with a reflective layer or a semi-transmissive reflective layer so as to be used as a reflective-type liquid crystal device or a semi-transmissive reflective liquid crystal device.

### Mother Opposing Substrate

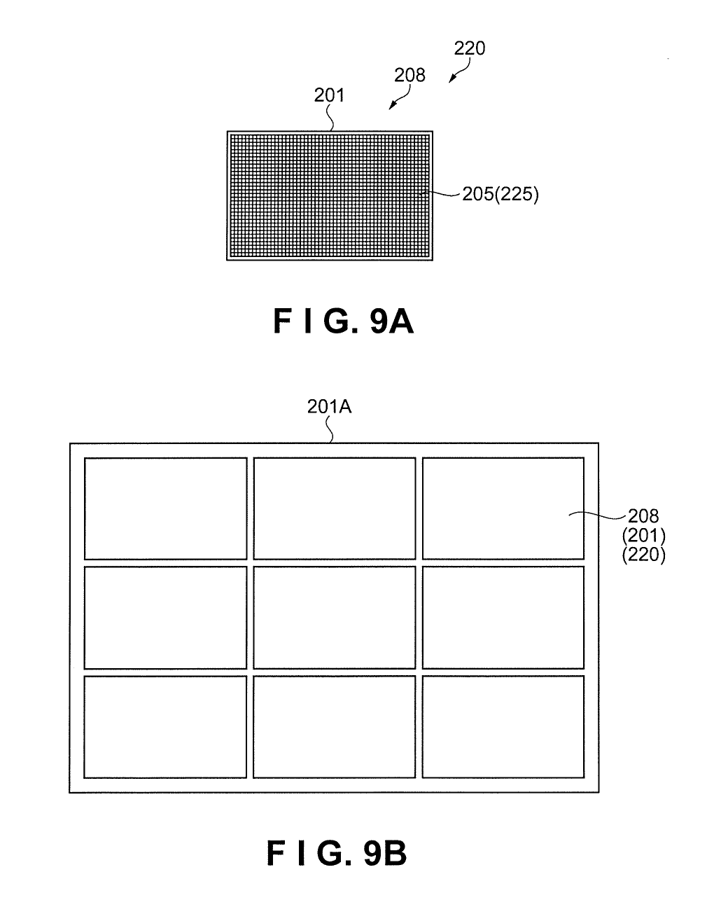

Next, a mother opposing substrate 201A will be described with reference to FIG. 9. The opposing substrate 220 is divided into sections to form the CF layer 208 or the like described above on the mother opposing substrate 201A acting as the glass substrate 201. The mother opposing substrate 201A is divided and formed into individual opposing substrates 220 (glass substrates 201). FIG. 9A is a plan view schematically showing the planar structure of an opposing substrate, and FIG. 9B is a plan view schematically showing the planar structure of a mother opposing substrate. In the present embodiment, the structure obtained by forming the CF layer 208 or the like on the mother opposing substrate 201A, or the state obtained by forming the CF layer 208 or the like will be referred to as the mother opposing substrate 201A.

The opposing substrate 220 is formed using the glass substrate 201 composed of a transparent quartz glass having a thickness of about 1.0 mm. The opposing substrate 220 has the CF layer 208 formed in portions that do not include a narrow frame region at the periphery of the glass substrate 201, as shown in FIG. 9A. The CF layer 208 is formed by forming a plurality of filter film regions 225 in a dot pattern shape on the surface of the quadrangular glass substrate 201, i.e., a dot matrix shape in the present embodiment, and forming a filter film 205 on the filter film region 225. An alignment mark (not shown) is formed in a position that is not located in the region in which the CF layer 208 of the glass substrate 201 is formed. The alignment mark is used as a reference mark for positioning when the glass substrate 201 is mounted on the manufacturing apparatus of the droplet discharge device 1 or the like or at other times in order to perform various steps for forming the CF layer 208 or the like.

The CF layer 208 of the opposing substrate 220 is formed on the mother opposing substrate 201A in each of the portions that are divided and serve as the glass substrate 201, as shown in FIG. 9B. The mother opposing substrate 201A corresponds to a substrate.

### Array of Color Films

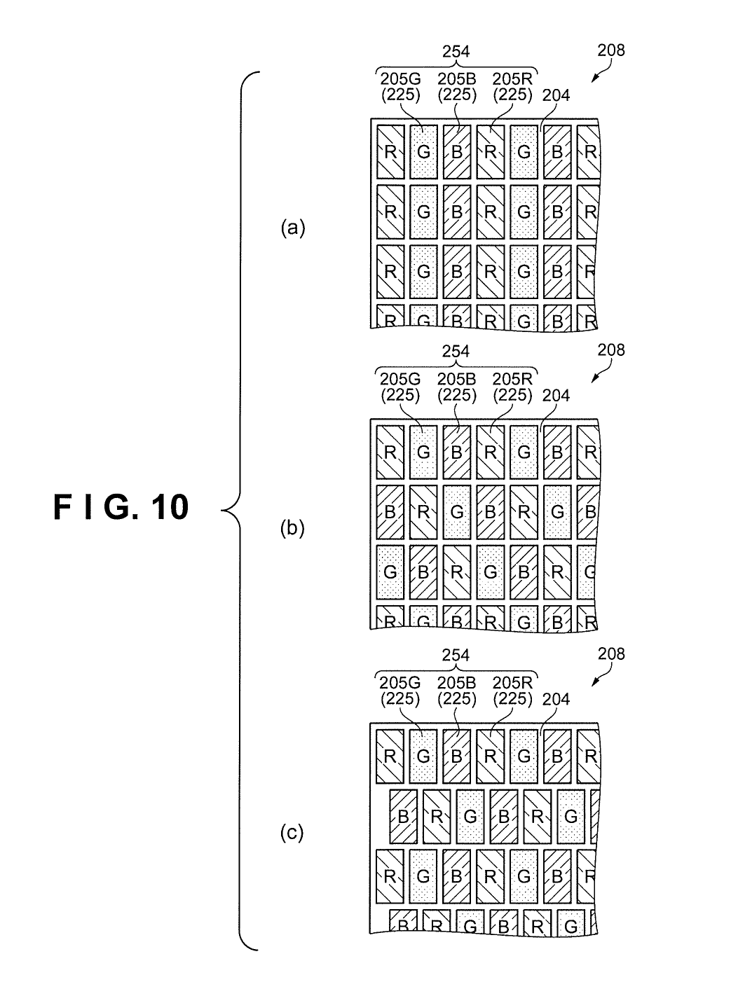

Described next with reference to FIG. 10 is the array of filter films 205 (the red filter film 205R, the green filter film 205G, and the blue filter film 205B) or the like in the CF layer 208 or the like formed on the opposing substrate 220 or the like. FIG. 10 is a schematic plan view showing an example of an array of filter films of a tricolored color filter.

The filter film 205 is partitioned by the partition wall 204 formed in a grid-shaped pattern using a non-transmissive resin material and is formed by using color materials to embed a plurality of, e.g., the quadrangular filter film regions 225 aligned in the form of a dot matrix, as shown in FIG. 10. For example, the functional liquid containing color materials that will constitute the filter film 205 is filled into the filter film region 225, and the solvent of the functional liquid is allowed to evaporate and the functional liquid dried to form the film-like filter film 205 for embedding the filter film region 225. The filter film region 225 corresponds to a functional film partitioned area, and the filter films 205 correspond to functional films. The functional film containing a color material constituting the filter films 205 corresponds to the liquid containing the material of the functional film.

Examples of known arrays of the red filter film 205R, the green filter film 205G, the blue filter film 205B, and the like in a tri-colored filter include a stripe array, a mosaic array, and a delta array. FIG. 10(a) is a schematic plan view showing a stripe array, FIG. 10(b) is a schematic plan view showing a mosaic array, and FIG. 10(c) is a schematic plan view showing a delta array.

A strip array is an array composed of the red filter film 205R, the green filter film 205G, and the blue filter film 205B, in which all of the longitudinal columns of a matrix have the same color, as shown in FIG. 10(a).

A mosaic array is an array in which the filter films 205 are offset by a single color for each row in the lateral direction, as shown in FIG. 10(b), and, in the case of a tri-colored filter, is a tri-colored array in which any three filter films 205 are rectilinearly aligned in the lateral and longitudinal directions.

A delta array is an array in which the arrangement of the filter films 205 is set in a stepped configuration and any three adjacent filter films 205 differ in color in the case of a tri-color filter, as shown in FIG. 10(c).

In the three color filters shown in FIGS. 10(a), (b), or (c), the filter films 205 are formed by any single color material among R (red), G (green), and B (blue). A filter composed of picture elements (hereinafter referred to as “picture element filter 254”), which are the smallest units constituting an image, are formed in an assembly of filter films 205 that include one each of the adjacently formed red filter film 205R, green filter film 205G, and blue filter film 205B. A full color display is carried out by adjusting the luminous energy of light to be transmitted and by selectively transmitting light using one or any combination of a red filter film 205R, a green filter film 205G, and a blue filter film 205B, in a single picture element filter 254.

### Formation of Liquid Crystal Display Panel

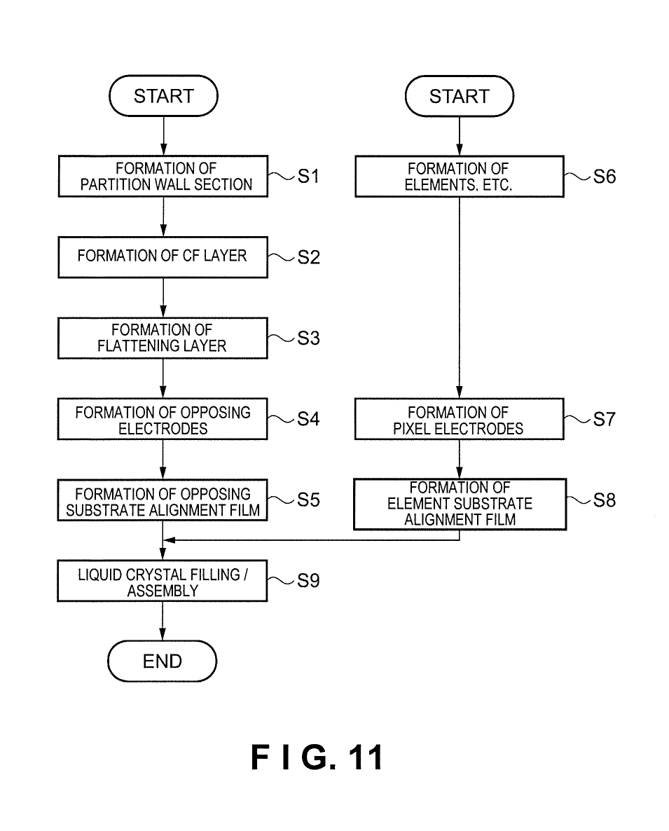

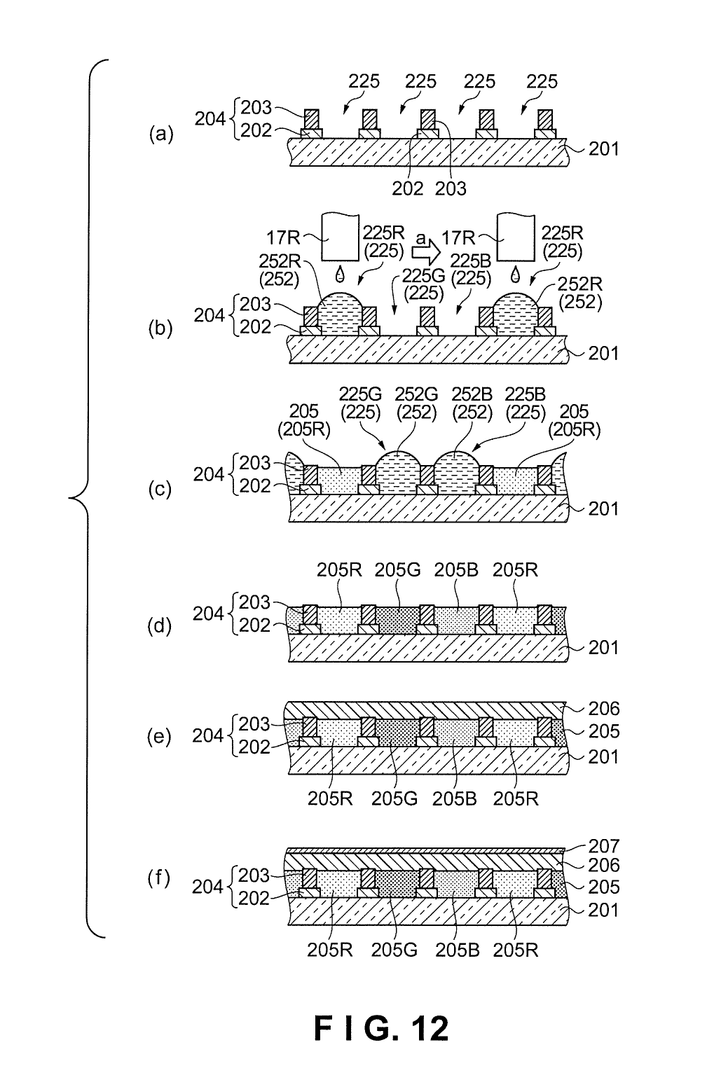

The steps for forming the liquid crystal display panel 200 will be described next with reference to FIGS. 11, 12, and 13. FIG. 11 is a flowchart that shows the process for forming a liquid crystal display panel. FIG. 12 is a cross-sectional view showing the steps for forming a filter film in the process for forming a liquid crystal display panel. FIG. 13 is a cross-sectional view showing the steps for forming an alignment film in the process for forming a liquid crystal display panel. The liquid crystal display panel 200 is formed by bonding together the element substrate 210 and the opposing substrate 220, which are separately formed.

The opposing substrate 220 is formed by carrying out steps 51 through S5 shown in FIG. 11.

In step S1, partition wall sections for partitioning and forming the filter film region 225 are formed on the glass substrate 201. The partition wall sections partition the black matrix 202 into a grid shape, and are formed by forming a bank 203 on the black matrix and arranging the partition wall 204 composed of the black matrix 202 and the bank 203 in a grid shape. The quadrangular filter film region 225 partitioned by the partition wall 204 is thereby formed on the surface of the glass substrate 201, as shown in FIG. 12(a).

Next, in step S2 of FIG. 11, the red filter film 205R, the green filter film 205G, and the blue filter film 205B are formed to obtain the CF layer 208. The red filter film 205R, the green filter film 205G, and the blue filter film 205B are formed by filling the filter film region 225 with functional liquid containing material that constitutes the red filter film 205R, the green filter film 205G, or the blue filter film 205B, and then drying the functional liquid.

More specifically, a red discharge head 17R is made to face the surface of the glass substrate 201 on which the filter film region 225 partitioned by the partition wall 204 is formed, as shown in FIG. 12(b). A red functional liquid 252R is deposited in a filter film region 225R by discharging the red functional liquid 252R from the discharge nozzles 78 of the red discharge head 17R toward the filter film region 225R in which the red filter film 205R is to be formed. At the same time, the red discharge head 17R is moved in a relative fashion with respect to the glass substrate 201 in the manner indicated by the arrow a, whereby the red functional liquid 252R is deposited in all the filter film regions 225R formed in the glass substrate 201. The red filter film 205R is formed in the filter film region 225R, as shown in FIG. 12(c), by drying the deposited red functional liquid 252R.

Similarly, green functional liquid 252G or blue functional liquid 252B is deposited in the filter film region 225G or the filter film region 225B in which the green filter film 205G or the blue filter film 205B shown in FIG. 12(b) is to be formed, as shown in FIG. 12(c). The green filter film 205G or the blue filter film 205B is formed in the filter film region 225G and the filter film region 225B, as shown in FIG. 12(d), by drying the green functional liquid 252G and the blue functional liquid 252B. In combination with the red filter film 205R, a tri-colored filter composed of the red filter film 205R, the green filter film 205G, and the blue filter film 205B is formed.

Next, a flattening layer is formed in the step S3 of FIG. 11. The flattening film 206 as the flattening layer is formed on the partition wall 204 as well as the red filter film 205R, the green filter film 205G, and the blue filter film 205B constituting the CF layer 208, as shown in FIG. 12(e). The flattening film 206 is formed in the region that covers at least the entire CF layer 208. The surface that forms the opposing electrodes 207 is made into a substantially flat surface by providing the flattening film 206.

Next, the opposing electrodes 207 are formed in step S4 of FIG. 11. A thin film is formed using a transparent electroconductive material in the region on the flattening film 206 that covers the entire surface of the region in which at least the filter films 205 of the CF layer 208 are formed, as shown in FIG. 12(f). This thin film is the opposing electrodes 207 described above.

Next, the alignment film 228 of the opposing substrate 220 is formed on the opposing electrodes 207 in step S5 of FIG. 11. The alignment film 228 is formed in the region that covers at least the entire surface of the CF layer 208.

The droplet discharge head 17 is made to face the surface of the glass substrate 201 on which the opposing electrodes 207 are formed, as shown in FIG. 13(g), and an alignment film liquid 242 is discharged from the droplet discharge head 17 toward the surface of the glass substrate 201. At the same time, the discharge head 17 is moved in a relative fashion with respect to the glass substrate 201 in the manner indicated by the arrow a, whereby the alignment film liquid 242 is deposited over the entire surface of the region in which the alignment film 228 of the glass substrate 201 is to be formed. The alignment film 228 is formed by drying the deposited alignment film liquid 242, as shown in FIG. 13(h). The opposing substrate 220 is thus formed by carrying out step S5.

The element substrate 210 is formed by carrying out steps S6 to S8 shown in FIG. 11.

In step S6, the TFT elements 215 and other elements, the scan lines 212, the signal lines 214, and the insulating layer 216 and the like are formed by forming an electroconductive layer, an insulating layer, and semiconductor layer on the glass substrate 211. The scan lines 212 and the signal lines 214 are formed in positions facing the partition wall 204, i.e., in positions at the periphery of the pixels in a state in which the element substrate 210 and the opposing substrate 220 have been bonded together. The TFT elements 215 are formed so as to be positioned at the edge of the pixels, and at least one TFT element 215 is formed on a single pixel.

The pixel electrodes 217 are formed next in step S7. The pixel electrodes 217 are formed in positions facing the red filter film 205R, the green filter film 205G, and the blue filter film 205B in a state in which the element substrate 210 and the opposing substrate 220 have been bonded together. The pixel electrodes 217 are electrically connected to the drain electrodes of the TFT elements 215.

Next, in step S8, the alignment film 218 of the element substrate 210 is formed on the pixel electrodes 217 or the like. The alignment film 218 is formed in at least a region that covers the entire surface of the all the pixel electrodes 217

The droplet discharge head 17 is made to face the surface of the glass substrate 211 on which the pixel electrodes 217 are formed, and the alignment film liquid 242 is discharged from the droplet discharge head 17 toward the surface of the glass substrate 211, as shown in FIG. 13(i). At the same time, the discharge head 17 is moved in a relative fashion with respect to the glass substrate 211 in the manner indicated by the arrow a, whereby the alignment film liquid 242 is deposited over the entire surface of the region in which the alignment film 218 of the glass substrate 211 is to be formed. The alignment film 218 is formed by drying the deposited alignment film liquid 242, as shown in FIG. 13(j). The element substrate 210 is thus formed by carrying out step S8.

Next, in step S9 shown in FIG. 11, the opposing substrate 220 and the element substrate 210 thus formed are bonded together and the liquid crystal 230 is filled therebetween, as shown in FIG. 13(k). A polarizing plate 231 and a polarizing plate 232 are furthermore bonded or otherwise affixed to complete the assembly of the liquid crystal display panel 200. A mother substrate on which a plurality of liquid crystal display panels 200 is formed is divided into individual liquid crystal display panels 200 in the case that a plurality of opposing substrates 220 and element substrates 210 are formed on the mother substrate composed of a plurality of glass substrates 201 and glass substrates 211. Alternatively, step S9 is carried out after the step for dividing the mother opposing substrate 201A and the mother element substrate into the opposing substrates 220 and the element substrates 210. Step S9 is carried out and the step for forming the liquid crystal display panel 200 is ended.

### Functional Liquid Arrangement

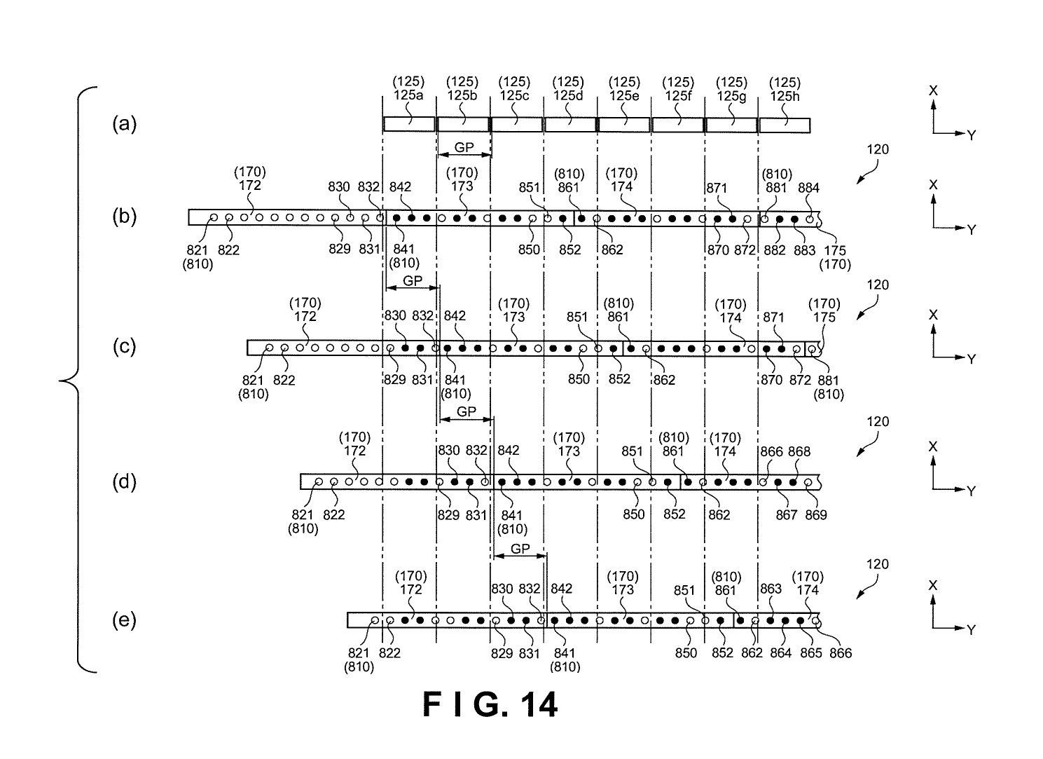

Described next with reference to FIG. 14 is the step for discharging functional liquid from the droplet discharge head 17 of the droplet discharge device 1 and depositing the functional liquid in the filter film region 225 and other filter films of the CF layer region in the mother opposing substrate. FIG. 14 is a descriptive view showing the relationship between the filter film region and the discharge nozzles that perform a discharge in the step for depositing the functional liquid. FIG. 14(a) is a descriptive view showing the array position of the Y-axis direction of the filter film region, and FIGS. 14(b), (c), (d), and (e) are descriptive views showing the discharge nozzles that perform discharges in the discharge scan.

A filter film region 125 and a droplet discharge head 170 as a simplified droplet discharge head 17 will be described as an example in order to simplify the drawing and facilitate understanding. The X-axis and Y-axis shown in FIG. 14 show the same directions as the X-axis and Y-axis shown in FIG. 1 in a state in which the head unit provided with the droplet discharge head 170 is mounted on the droplet discharge device in similar fashion to the state in which the head unit 21 is mounted on the droplet discharge device 1.

The droplet discharge head 170 has 12 discharge nozzles 810, as shown in FIG. 14. A head unit 120 provided with the droplet discharge head 170 is provided with nine droplet discharge heads 170 in the same manner as the head unit 21, and has nozzle rows composed of 108 discharge nozzles 810 of the nine droplet discharge head 170. FIGS. 14(b), (c), (d), and (e) show only the position in the Y-axis direction and the position offset in the X-axis direction of the droplet discharge heads 170 is omitted.

The droplet discharge heads 170 provided to the head unit 120 are referred to as, in order from the end, droplet discharge head 172, droplet discharge head 173, droplet discharge head 174, and droplet discharge head 175. The discharge nozzles 810 of the droplet discharge head 172, the droplet discharge head 173, the droplet discharge head 174, and the droplet discharge head 175 are referred to as discharge nozzles 821 to discharge nozzles 832, discharge nozzles 841 to discharge nozzles 852, discharge nozzles 861 to discharge nozzles 872, and discharge nozzles 881 to discharge nozzles 892. The fifth droplet discharge head 170 and thereafter of the head unit 120 are omitted from the drawing. In FIGS. 14(b), (c), (d), and (e), the discharge nozzles 810 that will perform a discharge are shown as black circles, and the discharge nozzles 810 that will not perform a discharge are shown as white circles.

Filter film regions 125 are arrayed at a pitch interval of a region pitch GP in the Y-axis direction. FIG. 14(a) shows only a single column of the filter film regions 125, and the CF layer region has a configuration in which a column of the filter film regions 125 shown in FIG. 14(a) is arrayed in the X-axis direction. Filter film regions 125 are referred to as a filter film region 125a, a filter film region 125b, and a filter film region 125c in sequence from the end of the CF layer region. A filter film region 125 corresponds to a functional film partitioned area.

The filter film regions 125 in the present embodiment are formed by carrying out four discharge scans and depositing a total of 10 droplets of functional liquid 252 in a single filter film region 125.

In the first discharge scan, the discharge nozzles 841, 842, 843, 845, 846, 848, 849, 852 of the droplet discharge head 173, the discharge nozzles 861, 863, 864, 865, 867, 868, 870, 871 of the droplet discharge head 174, and the discharge nozzles 882, 883 of the droplet discharge head 175 perform a discharge in the range shown in FIG. 14(b). The droplets discharged from the discharge nozzles 841, 842, 843 of the droplet discharge head 173 land in the filter film region 125a. Although not shown in the drawing, among the nine droplet discharge heads 170 constituting the head unit 120, eight droplet discharge heads 170 excluding the droplet discharge head 172 perform a discharge in the first discharge scan.

Following the first discharge scan, a secondary scan is performed and a second discharge scan is carried out. The secondary scan moves the head unit 120 from the position of the first discharge scan by a distance equal to the region pitch GP in the Y-axis direction.

In the second discharge scan, the discharge nozzles 830, 831 of the droplet discharge head 172, the discharge nozzles 841, 842, 843, 845, 846, 848, 849, 852 of the droplet discharge head 173, and the discharge nozzles 861, 863, 864, 865, 867, 868, 870, 871 of the droplet discharge head 174 perform a discharge in the range shown in FIG. 14(c). The droplets discharged from the discharge nozzles 841, 842, 843 of the droplet discharge head 173 land in the filter film region 125b. In the second discharge scan, the width of the CF layer region in the Y-axis direction in which the ninth droplet discharge head 170 performs a discharge is narrower than the width in the first discharge scan by a distance equal to the width of the CF layer region in the Y-axis direction in which the droplet discharge head 172 performs a discharge. In the second discharge scan, the functional liquid 252 is thereby deposited in eight filter film regions 125 at the same width of the droplet discharge head 170 in the first discharge scan.

Following the second discharge scan, a secondary scan is performed and a third discharge scan is carried out. The secondary scan moves the head unit 120 from the position of the second discharge scan by a distance equal to the region pitch GP in the Y-axis direction.

In the third discharge scan, the discharge nozzles 827, 828, 830, 831 of the droplet discharge head 172, the discharge nozzles 841, 842, 843, 845, 846, 848, 849, 852 of the droplet discharge head 173, and the discharge nozzles 861, 863, 864, 865, 867, 868 of the droplet discharge head 174 perform a discharge in the range shown in FIG. 14(d). The droplets discharged from the discharge nozzles 841, 842, 843 of the droplet discharge head 173 land in the filter film region 125c. In the third discharge scan, the width of the CF layer region in the Y-axis direction in which the ninth droplet discharge head 170 performs a discharge is narrower than the width in the second discharge scan by a distance equal to the width of the CF layer region in the Y-axis direction in which the droplet discharge head 172 performs a discharge.

Following the third discharge scan, a secondary scan is performed and a fourth discharge scan is carried out. The secondary scan moves the head unit 120 from the position of the third discharge scan by a distance equal to the region pitch GP in the Y-axis direction.

In the fourth discharge scan, the discharge nozzles 823, 824, 827, 828, 830, 831 of the droplet discharge head 172, the discharge nozzles 841, 842, 843, 845, 846, 848, 849, 852 of the droplet discharge head 173, and the discharge nozzles 861, 863, 864, 865 of the droplet discharge head 174 perform a discharge in the range shown in FIG. 14(e). The droplets discharged from the discharge nozzles 841, 842, 843 of the droplet discharge head 173 land in the filter film region 125d. In the fourth discharge scan, the width of the CF layer region in the Y-axis direction in which the ninth droplet discharge head 170 performs a discharge is narrower than the width in the third discharge scan by a distance equal to the width of the CF layer region in the Y-axis direction in which the droplet discharge head 172 performs a discharge.

As described above, the discharge nozzles 810 that perform a discharge in the droplet discharge head 173 are invariable in the fourth discharge scan. The distribution of the discharge nozzles for performing discharges in the droplet discharge head is referred to as the “discharge-performing array.” The discharge nozzles 810 that perform a discharge in the fourth discharge scan are fixed as well in the case of the droplet discharge heads 170 from the droplet discharge head 174 to the eighth droplet discharge head 170 in the same manner as the droplet discharge head 173, and the discharge-performing array is constant in each of the droplet discharge heads 170. Since the discharge-performing array is constant, the effect in which the discharge nozzles 810 are mutually affected by the drive states of nearby discharge nozzles 810 is also constant. Therefore, the drive voltage and other drive conditions of the discharge nozzles 810 can be kept as constant drive conditions without adjustment because there is substantially no fluctuation in the discharge quantity due to the effect of fluctuations in the drive state of nearby discharge nozzles 810.

The region pitch GP corresponds to the functional film pitch. The secondary scan involving movement equal to the region pitch GP in the Y-axis direction corresponds to the first secondary scan, and the secondary scan step corresponds to the first secondary scan step.

The four discharge scans and three secondary scans are carried out, and in the example described here, functional liquid 252 is deposited in the filter film regions 125, which are eight regions in which the width in the Y-axis direction is equivalent to eight droplet discharge heads 170. The scan for completing the process of depositing functional liquid in the functional film partitioned areas of a predetermined range in the manner of the four discharge scans having three intervening secondary scans described above is referred as a “partition scan.” The range for completing the process for depositing the functional liquid in a single partition scan is referred as a “partition scan region.” In the example described herein, the partition scan region is a region having a width in the Y-axis direction equivalent to eight droplet discharge heads 170. Specifically, the region is one in which 96 discharge nozzles 810 corresponding to the 96 discharge nozzles 810 of eight droplet discharge heads 170 can face the partition scan region.

The next partition scan is carried out after a secondary scan has been performed for moving the head unit 120 in a relative fashion to a position in which the discharge nozzles 810 of the head unit 120 face the next partition scan region. This secondary scan is referred to as a “partition secondary scan.” The partition secondary scan moves the head unit 120 in a relative fashion a distance equal to the width of the partition scan region. The relative movement distance of the partition secondary scan in each individual case is a width that allows the 96 discharge nozzles 810 to face the partition scan region, and is an integral multiple of the nozzle pitch.

The discharge-performing array in the discharge scan following the partition secondary scan, which entails movement by a distance equal to the integral multiple of the nozzle pitch, is very likely to be different than the discharge-performing array in the discharge scan prior to the partition secondary scan. Accordingly, it is very likely that fluctuations in the discharge amount will occur due to the effect of fluctuations in the drive state of nearby discharge nozzles 810. The drive voltage and other drive conditions are adjusted for each individual discharge nozzle 810 in order to reduce the effect of differing discharge-performing arrays. The partition secondary scan in this case corresponds to the second secondary scan, and the partition secondary scan step corresponds to the second secondary scan step.

The width in which the functional liquid is deposited in the first discharge scan in a partition scan is an integral multiple of the region pitch GP, which is the arrangement pitch of the filter film regions 125 in the Y-axis direction, and the width in which the functional liquid is deposited in the second to fourth discharge scans is also the same, whereby the width in the Y-axis direction of the partition scan region is set to an integral multiple of the region pitch GP. In this case, the drive voltage and other drive conditions of the discharge nozzles 810 are kept as constant drive conditions without adjustment because there is substantially no fluctuation in the discharge quantity due to the effect of fluctuations in the drive state of nearby discharge nozzles 810. The partition secondary scan in this case corresponds to the first secondary scan, and the partition secondary scan step corresponds to the first secondary scan step.

The same applies to the case in which the functional liquid is deposited in the filter film region 225 using the head unit 21 and to the case in which the functional liquid is deposited in the filter film regions 125 using the head unit 120.

### Functional Liquid Arrangement-2

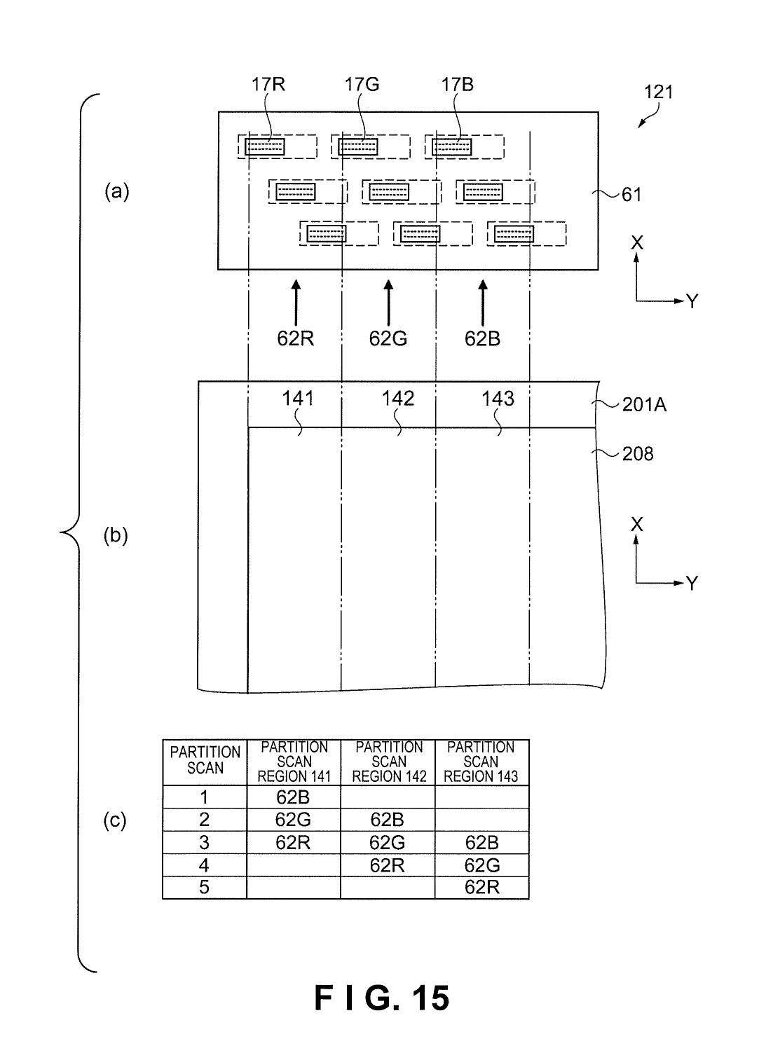

Described next with reference to FIG. 15 is another example of the step for discharging functional liquid from the droplet discharge head 17 of the droplet discharge device 1 and depositing the functional liquid in the filter film region 225 and other filter films of the CF layer in the mother opposing substrate. FIG. 15 is a descriptive view showing the relationship between the CF layer region and the droplet discharge head that performs discharges in the step for depositing the functional liquid. FIG. 15(a) is a plan view showing the general configuration of the head unit. FIG. 15(b) is a plan view showing the partition scan regions in the CF layer region. FIG. 15(c) is a table of the head groups that perform a discharge for each partition scan region.

The head unit 121 shown in FIG. 15(a) has the same configuration as the head unit 21 described above. The X-axis and Y-axis shown in FIG. 15(a) match the X-axis and Y-axis shown in FIG. 1 in a state in which the head unit 121 is mounted on the droplet discharge device 1 in the same manner as the head unit 21. The head unit 121 has a configuration in which three types of functional liquid corresponding to a tri-colored filter are deposited, which is different from that of the head unit 21. The head unit 121 is provided with a red head assembly 62R, a green head assembly 62G, and a blue head assembly 62B. The red head assembly 62R is composed of a red discharge head 17R for discharging red functional liquid 252R containing a material for forming a red filter film 205R. The red head assembly 62R is provided with three red discharge heads 17R. The green head assembly 62G is composed of a green discharge head 17G for discharging green functional liquid 252G containing a material for forming a green filter film 205G. The green head assembly 62G is provided with three green discharge heads 17G. The blue head assembly 62B is composed of a blue droplet discharge head 17B for discharging blue functional liquid 252B containing a material for forming a blue filter film 205B. The blue head assembly 62B is provided with three blue droplet discharge heads 17B.

The positional relationship between the three discharge heads; i.e., the red discharge head 17R, the green discharge head 17G, and the blue droplet discharge head 17B, is the same as the positional relationship between the droplet discharge heads 17 in the head assembly 62 of the head unit 21. The positional relationship between the red head assembly 62R, the green head assembly 62G, and the blue head assembly 62B is the same as the positional relationship between the head assemblies 62 in the head unit 21.

The discharge scan is carried out in units of the red head assembly 62R, the green head assembly 62G, or the blue head assembly 62B. The configuration in which the nozzle row for depositing droplets in substantially the same position in the X-axis direction is a head assembly nozzle row is different from the discharge scan described above in which the nozzle row is a unit nozzle row. A partition scan region 141, a partition scan region 142, and a partition scan region 143 have a width that corresponds to the length of the head assembly nozzle row in the Y-axis direction in the red head assembly 62R, the green head assembly 62G, and the blue head assembly 62B, as shown in FIG. 15(b). In other words, the arrangement pitch of the partition scan region 141, the partition scan region 142, and the partition scan region 143 in the Y-axis direction is substantially the same as the arrangement pitch of the red head assembly 62R, the green head assembly 62G, and the blue head assembly 62B in the Y-axis direction.

In the first partition scan 1, the blue functional liquid 252B is deposited in the blue filter film region 225B of the partition scan region 141 by the blue head assembly 62B, as shown in FIG. 15(c).

Next, in partition scan 2, the blue functional liquid 252B is deposited in the blue filter film region 225B of the partition scan region 142 by the blue head assembly 62B, and the green functional liquid 252G is deposited in the green filter film region 225G of the partition scan region 141 by the green head assembly 62G.

Then, in partition scan 3, the blue functional liquid 252B is deposited in the blue filter film region 225B of the partition scan region 143 by the blue head assembly 62B, the green functional liquid 252G is deposited in the green filter film region 225G of the partition scan region 142 by the green head assembly 62G, and the red functional liquid 252R is deposited in the red filter film region 225R of the partition scan region 141 by the red head assembly 62R.

Subsequently, in partition scan 4, the green functional liquid 252G is deposited in the filter film region 225G of the partition scan region 143 by the green head assembly 62G, and the red functional liquid 252R is deposited in the filter film region 225R of the partition scan region 142 by the red head assembly 62R.

Next, in partition scan 5, the red functional liquid 252R is deposited in the filter film region 225R of the partition scan region 143 by the red head assembly 62R.

The red functional liquid 252R, the green functional liquid 252G, and the blue functional liquid 252B are deposited in the filter film region 225R, the filter film region 225G, and the filter film region 225B, respectively, in the partition scan region 141, the partition scan region 142, and the partition scan region 143 by carrying out partition scans 1 through 5.

In the partition scans 1 though 5 described above, the relative movement distance in the secondary scan carried out between discharge scans is an integral multiple of the region pitch, which is the arrangement pitch of the filter film regions 225 in the Y-axis direction in the same manner as the section titled “Functional liquid arrangement” described above. Therefore, the discharge nozzles 78 that perform a discharge are fixed in the four discharge scans carried out in each of the partition scans, and the discharge-performing array is constant in each of the droplet discharge heads 17. Since the discharge-performing array is constant, the effect in which the discharge nozzles 78 are mutually affected by the drive states of nearby discharge nozzles 78 is also constant. Therefore, the drive voltage and other drive conditions of the discharge nozzles 78 can be kept as constant drive conditions without adjustment because there is substantially no fluctuation in the discharge quantity due to the effect of fluctuations in the drive state of nearby discharge nozzles 78.

The secondary scan involving movement equal to the integral multiple of the region pitch of the filter film regions 225 in the Y-axis direction carried out in each of the partition scans corresponds to the first secondary scan, and the secondary scan step corresponds to the first secondary scan step.

As described above, the partition scan region 141, the partition scan region 142, and the partition scan region 143 have a width corresponding to the length of the head assembly nozzle row in the Y-axis direction in the red head assembly 62R, the green head assembly 62G, and the blue head assembly 62B. Accordingly, the relative movement distance in the partition secondary scans between the partition scans 1 through 5 is a movement distance that corresponds to the length of the head assembly nozzle row in the Y-axis direction, and is length that is an integral multiple of the nozzle pitch in the nozzle row.

The discharge-performing array in the discharge scan following the partition secondary scan in which movement is equal to an integral multiple of the nozzle pitch is very likely to be different from the discharge-performing array in the discharge scan prior to the partition secondary scan. Accordingly, it is very likely that fluctuations in the discharge quantity will occur due to the effect of fluctuations in the drive state of the nearby discharge nozzles 78. This effect is reduced by adjusting the drive voltage and other drive conditions for each individual discharge nozzle 78 prior to the first discharge scan of each of the partition scans 1 through 5. The partition secondary scan in this case corresponds to the second secondary scan, and the partition secondary scan step corresponds to the second secondary scan step.

The width in which the functional liquid is deposited in the first discharge scan in the partition scans 1 through 5 described above is an integral multiple of the region pitch, which is the arrangement pitch of the filter film regions 225 in the Y-axis direction, and the width in which the functional liquid is deposited in the second to fourth discharge scans is also the same, whereby the arrangement pitch of the partition scan regions in the Y-axis direction is an integral multiple of the region pitch. Since the relative movement distance in the partition secondary scan in this case is an integral multiple of the region pitch, the array of the discharge nozzles 78 that perform a discharge is constant when the red head assembly 62R, the green head assembly 62G, and the blue head assembly 62B perform a discharge in the partition scans 1 through 5. Therefore, the drive voltage and other drive conditions of the discharge nozzles 78 are kept as constant drive conditions without adjustment because there is substantially no fluctuation in the discharge quantity caused by the effect of fluctuations in the drive state of nearby discharge nozzles 78. The partition secondary scan in this case corresponds to the first secondary scan, and the partition secondary scan step corresponds to the first secondary scan step.

More specifically, in the first partition scan 1, there is a filter film region 225B in the first, second, and third discharge scans in which the blue functional liquid 252B cannot be deposited in the filter film region 225B of the partition scan region 142 side in the partition scan region 141, and a specified quantity of the blue functional liquid 252B cannot be deposited in the filter film region 225B. However, in the first, second, and third discharge scans of the subsequent partition scan 2, the discharge nozzles 78 on the partition scan region 141 side in the nozzle row facing the partition scan region 142 is positioned facing the filter film region 225B of the partition scan region 141. Accordingly, the blue functional liquid 252B that is less than a specified quantity can be supplemented in the partition scan 2 in filter film region 225B in which the specified quantity of the blue functional liquid 252B could not be deposited in the partition scan 1 using the discharge nozzles 78. The same applies to the other partition scan region 142 and partition scan region 143, and the same applies to other functional liquids 252 other than the functional liquid 252B.

The effects of the first embodiment are described below. According to the first embodiment, the following effects are obtained.

(1) In the secondary scans between the discharge scans, the head unit 120 is moved a distance equal to the region pitch GP in the Y-axis direction from the position of the discharge scan prior to the secondary scan. Accordingly, the portion of the filter film regions 125 facing the discharge nozzles 810 in the discharge scans between the secondary scans is the same for most of the discharge nozzles 810. For example, the discharge nozzles 841 facing the edge of the filter film region 125a in the first discharge scan face the edge of the filter film region 125b, the filter film region 125c, or the filter film region 125d in the subsequent discharge scan as well. Therefore, the discharge nozzles 841 perform a discharge in any of the discharge scans as well. The discharge-performing array of the discharge nozzles 810 can thereby be shared in any discharge scan in the nozzle rows of the droplet discharge head 173 and other droplet discharge heads 170.

(2) The drive voltage and other drive conditions of the discharge nozzles 810 can be kept as constant drive conditions without adjustment in four discharge scans. The time required for the CPU 44 to obtain the drive conditions and the load imposed on the CPU 44 and other discharge device control sections 6 can thereby be reduced.

(3) The drive voltage and other drive conditions of the discharge nozzles 810 are adjusted in the discharge scan following the partition secondary scan. The discharge-performing array in the discharge scan following the partition secondary scan, which entails movement by a distance equal to the integral multiple of the nozzle pitch, is very likely to be different than the discharge-performing array in the discharge scan prior to the partition secondary scan. Therefore, it is very likely that fluctuations in the discharge amount will occur due to the effect of fluctuations in the drive state of nearby discharge nozzles 810. The drive voltage and other drive conditions of the discharge nozzles 810 are adjusted in order to reduce fluctuations in the discharge quantity.

(4) In the partition scans 1 though 5 described above, the relative movement distance in the secondary scan carried out between discharge scans is an integral multiple of the region pitch of the filter film regions 225. Therefore, the discharge nozzles 78 that perform a discharge is fixed in the four discharge scans carried out in each of the partition scans, and the discharge-performing array can be made constant in each of the droplet discharge heads 17.

(5) In the partition scans 1 though 5 described above, the drive voltage and other drive conditions of the discharge nozzles 78 can be kept as constant drive conditions without adjustment in four discharge scans carried out in each of the partition scans. The time required for the CPU 44 to obtain the drive conditions and the load imposed on the CPU 44 and other discharge device control sections 6 can thereby be reduced.

(6) The relative movement distance in the partition scans carried out between the partition scans 1 through 5 is a movement distance that corresponds to the length of the head assembly nozzle row in the Y-axis direction, and is a length that is an integral multiple of the nozzle pitch. Accordingly, all of the discharge nozzles of the head assembly nozzle row can be used and partition scan regions in which functional liquid is to be deposited by each partition scan can be formed without a gap.

(7) The drive voltage and other drive conditions of individual discharge nozzles 78 are adjusted prior to the first discharge scan of each of the partition scans 1 through 5. Fluctuations in the discharge quantity from the discharge nozzles 78 caused by fluctuations in the discharge-performing array can be reduced because the relative movement distance in the partition secondary scan is the length of an integral multiple of the nozzle pitch.

### Second Embodiment

Described next with reference to the drawings is a second embodiment of the method for manufacturing an electro-optical device and an apparatus for manufacturing an electro-optical device. The present embodiment will be described using a manufacturing method and a manufacturing device as an example in which a step is used for forming a hole-transport layer and a luminescent layer, which are examples of a functional film, in the step for manufacturing an organic EL display device, which is an example of an electro-optical device. The droplet discharge device used in the present embodiment has essentially the same configuration as the droplet discharge device 1 described in the first embodiment. In relation to the droplet discharge device, the configuration of a head unit that is different from the head unit 21 of the droplet discharge device 1 will be described.

### Configuration of Organic EL Display Device

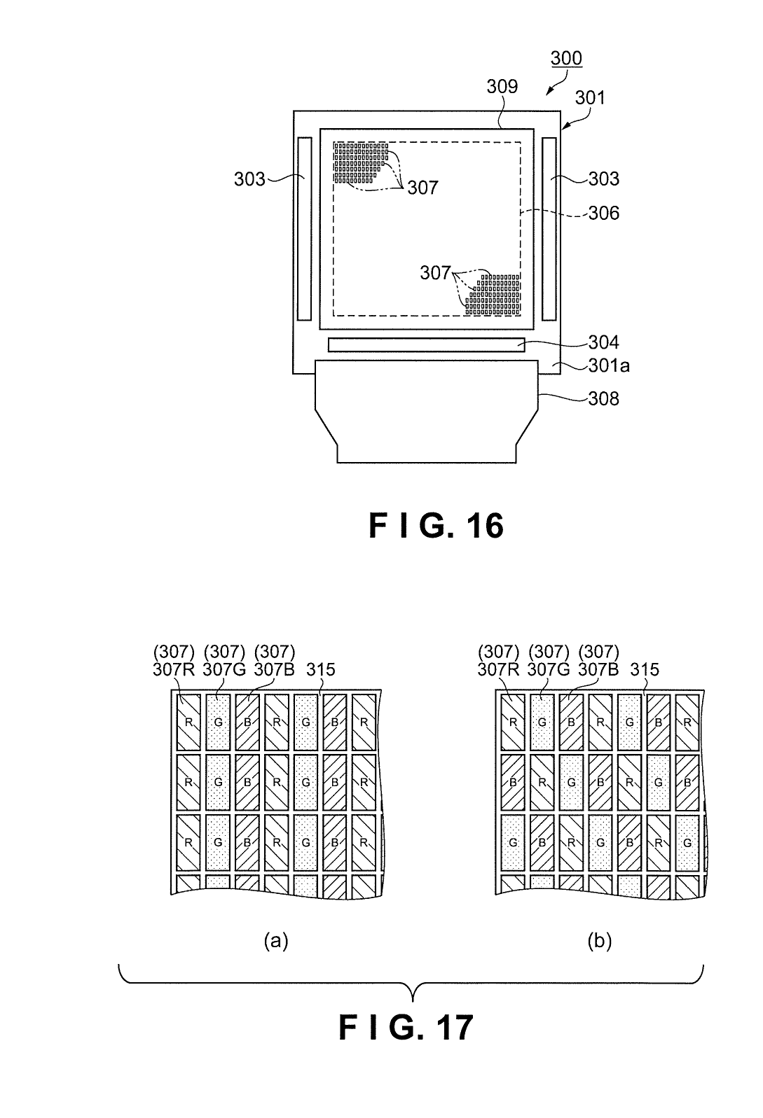

First, the configuration of an organic EL display device will be described with reference to FIGS. 16, 17, and 18. FIG. 16 is a schematic front view showing the plan configuration of the organic EL display device. FIG. 17 is a plan view showing the arrangement example of the organic EL display device.

An organic EL display device 300 is provided with a sealed substrate 309 and an element substrate 301 having a plurality of organic EL elements 307 as light-emitting elements, as shown in FIG. 16. The organic EL elements 307 are so-called color elements, and the organic EL display device 300 has three colored organic EL elements 307, namely, a red element 307R (red colors), a green element 307G (green colors), and a blue element 307B (blue colors), as shown in FIG. 17. The organic EL elements 307 are disposed in a display region 306, and an image is displayed in the display region 306.

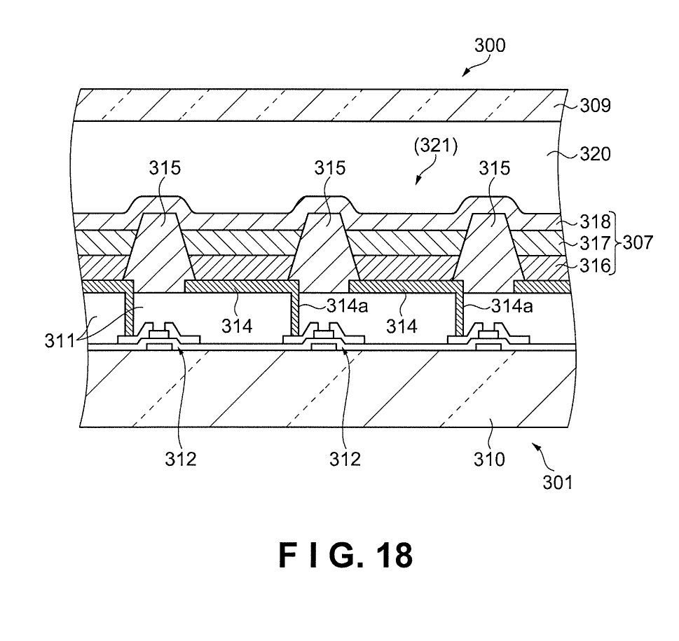

The tricolored organic EL elements 307 on the element substrate 301 are formed by being partitioned by the partition walls 315 formed in a grid-shaped pattern using a non-transmissive resin material and forming the luminescent layer 317 (see FIG. 18) or the like in a plurality of, e.g., the substantially quadrangular regions aligned in the form of a dot matrix, as shown in FIGS. 17(a) and 17(b). For example, the functional liquid containing the material of the luminescent layer 317 and the hole-transport layer 316 (see FIG. 18) constituting the organic EL elements 307 is introduced into the pixel region 321 (see FIG. 18) partitioned by the partition wall 315, and the solvent of the functional liquid is allowed to evaporate and the functional liquid is allowed to dry to form the hole-transport layer 316 and the luminescent layer 317. The hole-transport layer 316 and the luminescent layer 317 correspond to the functional film, and the functional liquid containing the material of the hole-transport layer 316 and the luminescent layer 317 correspond to the liquid.

The element substrate 301 is provided with a plurality of switching elements 312 (see FIG. 18) as drive elements in positions that correspond to the organic EL elements 307. The switching elements 312 are, e.g., TFT (thin film transistor) elements. Two scan line drive circuits 303 for driving the switching elements 312 and a single data line drive circuit 304 are provided to the portion that protrudes in the shape of a frame so as to be somewhat larger than the sealed substrate 309. A flexible relay substrate 308 for connecting the scan line drive circuits 303 or the data line drive circuit 304 to an external drive circuit is mounted on a terminal section 301a of the element substrate 301. The scan line drive circuits 303 and the data line drive circuit 304 are configured by, e.g., forming in advance a low-temperature polysilicon semiconductor layer on the surface of the element substrate 301.

A stripe array, a mosaic array, and a delta array are known examples of arrays of the organic EL elements 307. A strip array is an array composed of the organic EL elements 307 in which all of the longitudinal columns of a matrix have the same color, as shown in FIG. 17(a). A mosaic array is an array in which the organic EL elements 307 are offset by a single color for each row in the lateral direction, and is a tricolor array of any three of the organic EL elements 307 aligned in the lateral and longitudinal directions in the case of a tricolor organic EL display device, as shown in FIG. 17(b). A delta array (not shown in FIG. 17) is a color arrangement in which the arrangement of the organic EL elements 307 is set in a stepped configuration and any three adjacent organic EL elements 307 differ in color in the case of a tricolor organic EL display device.

Next, the configuration of the organic EL elements 307 of the organic EL display device 300. FIG. 18 is a cross-sectional view of the main parts including the organic EL elements of the organic EL display device. The element substrate 301 has a glass substrate 310, a plurality of switching elements 312 formed one of the surfaces of the glass substrate 310, an insulating layer 311 formed so as to cover the switching elements 312, a plurality of pixel electrodes 314 connected to the switching elements 312 via a conductive layer 314a, and partition walls 315 formed between the plurality of pixel electrodes 314, as shown in FIG. 18. Also provided are a hole-transport layer 316 formed on the pixel electrodes 314 in the region partitioned by the partition walls 315 (hereinafter referred to as “pixel region 321”), a luminescent layer 317 layered and formed on the hole-transport layer 316, and opposing electrodes 318 provided so as to cover the luminescent layer 317 and the partition walls 315. The organic EL display device 300 has a sealed substrate 309 deposed so as to face the opposing electrodes 318 of the element substrate 301, and an inert gas 320 sealed between the opposing electrodes 318 and the sealed substrate 309. The hole-transport layer 316, the luminescent layer 317, and the opposing electrodes 318 formed on the pixel electrodes 314 in the regions partitioned by the partition walls 315 correspond to the organic EL elements 307.

The red element 307R, the green element 307G, and the blue element 307B are formed on the pixel region 321 by forming a red luminescent layer 317R (red colors), a green luminescent layer 317G (green colors), and a blue luminescent layer 317B (blue colors) for emitting red, green, and blue light, respectively. Picture elements as the smaller units constituting an image are formed by an assembly of organic EL elements 307 containing one each of the red element 307R, the green element 307G, and the blue element 307B. A full color display is carried out by selectively emitting light using one or any combination of the red element 307R, the green element 307G, and the blue element 307B in the a single picture element.

### Manufacture of Organic EL Display Device

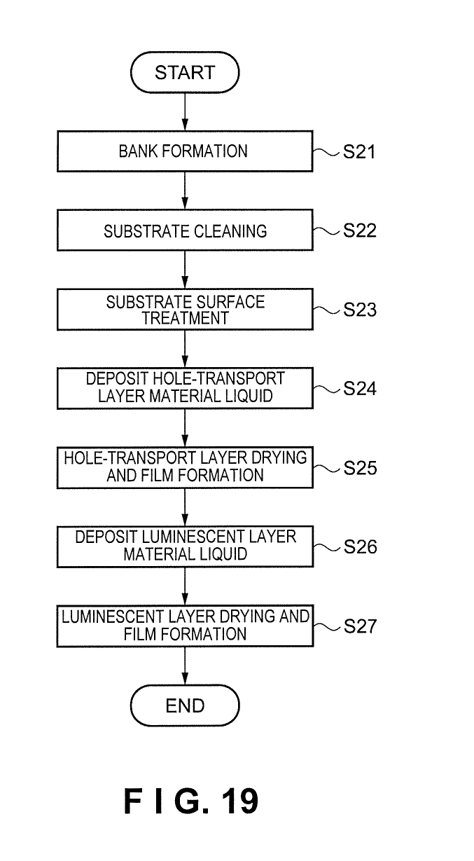

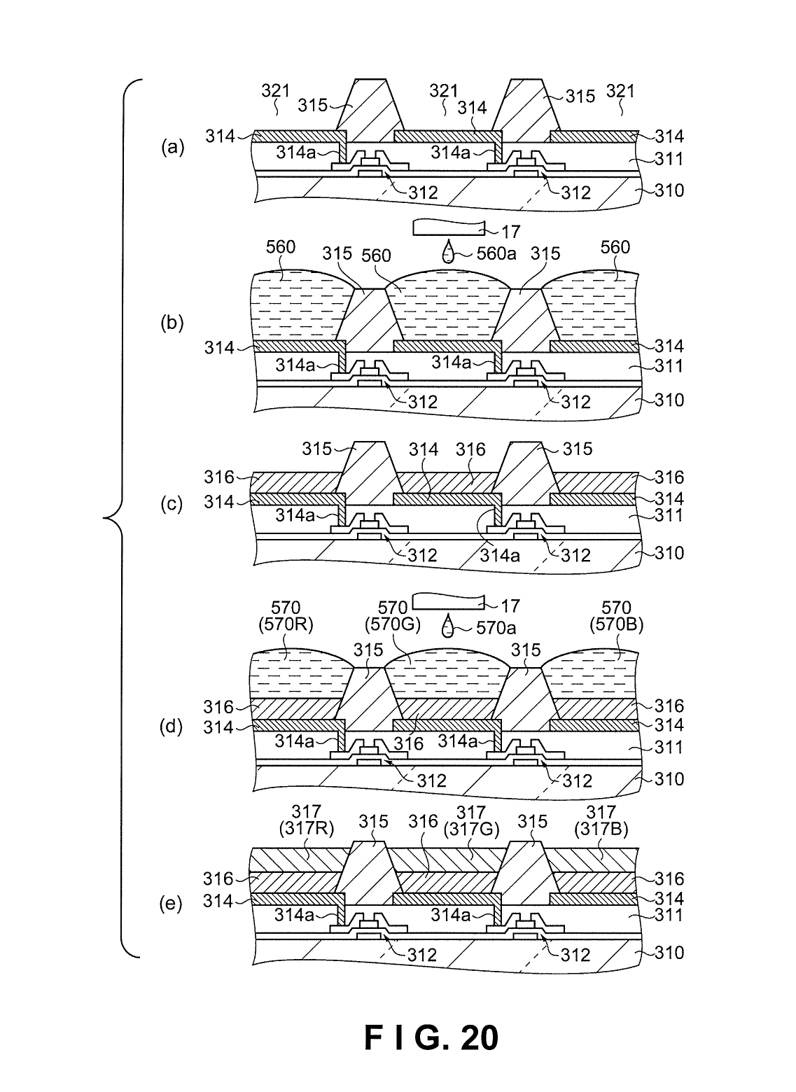

Next, the steps for forming the hole-transport layer 316 and the luminescent layer 317 constituting the organic EL elements 307 on the element substrate 301 of the organic EL display device 300 will be described with reference to FIGS. 19 and 20. FIG. 19 is a flowchart that shows the process for forming a luminescent layer and a hole-transport layer of the element substrate. FIGS. 20(a) to 20(e) are schematic cross-sectional views showing the process for forming a luminescent layer and a hole-transport layer of the element substrate.

In step S21 of FIG. 19, partition walls 315 are formed on the surface of the glass substrate 310 on which the switching elements 312, the insulating layer 311, the conductive layer 314a, and the pixel electrodes 314 are formed, as shown in FIG. 20(a). The partition walls 315 are formed by coating the functional liquid containing the material of the partition walls 315 on the surface of the glass substrate 310, for example, drying the liquid to form the functional liquid, and removing the pixel region 321 and other portions by photo-etching.

Next, the glass substrate 310 on which the partition walls 315 are formed is washed in step S22 of FIG. 19.

Next, in step S23, the washed glass substrate 310 on which the partition walls 315 are formed is subjected to a surface treatment so that the deposited functional liquid more readily acclimates to the surfaces. The bottom portion of the pixel region 321 surrounded by the partition walls 315 and the side surface of the partition walls 315 are treated so as to become lyophilic in relation to the hole-transport layer material liquid 560, which is the functional liquid containing the hole-transport layer formation material used for forming the hole-transport layer 316. The top section of the partition walls 315 is treated so as to become liquid repellent to the hole-transport layer material liquid 560. This treatment makes it possible for the hole-transport layer material liquid 560 that is to be deposited and filled into the pixel region 321 to more readily acclimate to the pixel region 321 and to be less likely to overflow from the pixel region 321.

Next, the hole-transport layer material liquid 560 is deposited in step S24. The hole-transport layer material liquid 560 containing the material of the hole-transport layer 316 is discharged as droplets 560a from the droplet discharge head 17 to each of the plurality of pixel region 321 formed by the partition walls 315, as shown in FIG. 20(b).

More specifically, the discharge nozzles 78 of the droplet discharge head 17 are positioned so as to sequentially face the pixel region 321 for forming the hole-transport layer 316, and the hole-transport layer material liquid 560 is discharged as the droplets 560a and deposited in the pixel region 321. A predetermined amount of the hole-transport layer material liquid 560 is deposited in the pixel region 321, and the hole-transport layer material liquid arrangement step of the step S24 is ended.

Next, in step S25 of FIG. 19, the glass substrate 310 on which the hole-transport layer material liquid 560 has been deposited in the pixel region 321 is placed in a reduced atmosphere, the hole-transport layer material liquid 560 is dried, and the hole-transport layer 316 is formed. Strictly speaking, the hole-transport layer material liquid 560 starts drying from the moment the liquid is discharged as droplets 560a from the droplet discharge head 17, but the liquid can be made to solidify after having landed, wetted and spread in the pixel region 321, and stopped flowing, by adjusting the boiling point or the like of the solvent of the hole-transport layer material liquid 560. The step S25 is ended and the hole-transport layer 316 is formed, as shown in FIG. 20(c).

Next, a luminescent layer material liquid 570 is deposited in step S26 of FIG. 19. The luminescent layer material liquid 570 containing the material of the luminescent layer 317 is discharged as droplets 570a from the droplet discharge head 17 toward the plurality of pixel regions 321 in which the hole-transport layer 316 is formed and the luminescent layer material liquid 570 is deposited on the hole-transport layer 316 of the pixel region 321, as shown in FIG. 20(d). It shall be apparent that the luminescent layer material liquid 570 containing the luminescent layer material is discharged to each pixel region 321 in which the different-colored luminescent layers 317 are formed. For example, the luminescent layer material liquid 570R, the luminescent layer material liquid 570G, or the luminescent layer material liquid 570B containing the luminescent layer material for forming the luminescent layers 317 are discharged from the droplet discharge head 17 toward the pixel region 321 in which the red luminescent layer 317R (red colors), the green luminescent layer 317G (green colors), and the blue luminescent layer 317B (blue colors) are to be formed for emitting red, green, and blue lights in the case of a color display (see FIG. 17) that uses the tri-colored luminescent layer described above.

In the case that the surface treatment performed in step S23, in which the hole-transport layer material liquid 560 is made to more readily acclimate to the pixel region 321 and to be less likely to overflow from the pixel region 321, is not effective for the luminescent layer material liquid 570, the same surface treatment as the treatment carried out in step S23 is carried out before step S26 is carried out. The treatment carried out in this case is, of course, a surface treatment that makes the luminescent layer material liquid 570 more readily acclimate to the pixel region 321 and less liable to overflow from the pixel region 321.

A predetermined quantity of a luminescent layer material liquid 570R, a luminescent layer material liquid 570G, or a luminescent layer material liquid 570B is made to land in each of the pixel regions 321 in which the luminescent layer material liquid 570R, the luminescent layer material liquid 570G, or the luminescent layer material liquid 570B are to be deposited, and the luminescent layer material liquid arrangement step of step S26 is ended.

Next, in step S27, the glass substrate 310 on which the luminescent layer material liquid 570 has been deposited in the pixel region 321 is placed in a reduced atmosphere, the luminescent layer material liquid 570 is dried, and the luminescent layer 317 is formed. Strictly speaking, the luminescent layer material liquid 570 starts drying from the moment the liquid is discharged as droplets from the droplet discharge head 17, but the liquid can be made to solidify after having landed, wetted and spread in the pixel region 321, and stopped flowing, by adjusting the boiling point or the like of the solvent of the luminescent layer material liquid 570. The step S27 is ended and the luminescent layer 317 is formed, as shown in FIG. 20(e).

The luminescent layer 317 is formed, as shown in FIG. 20(e), and the step for forming the hole-transport layer 316 and the luminescent layer 317 is ended. The step for forming the opposing electrodes 318 is furthermore carried out and the element substrate 301 is formed. The sealed substrate 309 is mounted, the relay substrate 308 described above or the like is mounted, and the organic EL display device 300 is formed.

### Functional Liquid Arrangement-3

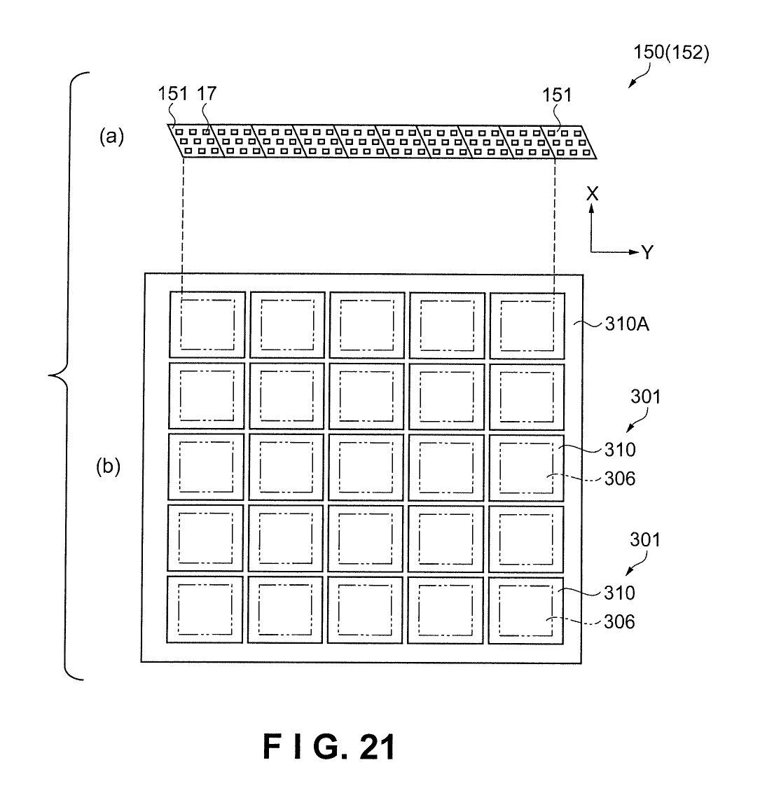

Described next with reference to FIG. 21 is another example of the step for discharging functional liquid from the droplet discharge head 17 of the droplet discharge device and depositing the functional liquid in a filter film region. The example of the present step is a step for depositing the hole-transport layer material liquid 560 in the pixel region 321 of the display region 306. FIG. 21 is a descriptive view showing the relationship between the pixel region and the arrangement of the droplet discharge heads for performing discharges in the step for depositing the functional liquid. FIG. 21(a) is a plan view showing the general configuration of the head unit group. FIG. 21(b) is a plan view showing the mother element substrate.

### Head Unit Group

First, the head unit group 150 will be described. The head mechanism section of the droplet discharge device described herein is provided with a head unit group 150 having nine head units 151, as shown in FIG. 21(a). The head units 151 have the same configuration as the head unit 21 described above and is provided with nine droplet discharge heads 17. The nine head units 151 are moved in the Y-axis direction by a Y-axis table in the same manner as the Y-axis table 12 described above, whereby the droplet discharge heads 17 are freely moved in the Y-axis direction, and are held in the moved position. The movement or holding of the nine head units 151 can be independently performed for each head unit 151, and can be performed in an integral fashion for two to nine of the head units. The distance in the Y-axis direction between the head units 151 can thereby be adjusted. The X-axis and Y-axis shown in FIG. 21(a) are the same directions as the X-axis and the Y-axis shown in FIG. 1 in a state in which the head unit group 150 has been mounted on the droplet discharge device in the same manner that the head unit 21 has been mounted on the droplet discharge device 1.

The 18 nozzle rows 78A of the nine droplet discharge heads 17 in the three head assemblies 62 provided to a single head unit 21 can be considered to be a single unit nozzle row as described above, and can similarly be considered to be a single unit nozzle row in the head units 151 as well.

In the head unit group 150, the adjacent head units 151 can be positioned so that the unit nozzle rows are mutually arranged at intervals of a single nozzle pitch (one-half the nozzle pitch in the nozzle rows 78A) in the unit nozzle row in the Y-axis direction. The interval of a single nozzle pitch is, more specifically, an interval in which the center distance between discharge nozzles 78 at the ends of the neighboring unit nozzle rows is a single nozzle pitch. The head units 151 are different from the head unit 21 in that the head units are arranged close together in the stated interval.

The 162 nozzle rows 78A of the 81 droplet discharge heads 17 in the nine head units 151 can be considered to be a single nozzle row by moving the nine head units 151 provided to head unit group 150 in an integrally fashion. This nozzle row is referred to as a “unit group nozzle row 152.” The unit group nozzle row 152 has, e.g., 180×162=29,160 discharge nozzles 78, and the nozzle pitch in the Y-axis direction is 70 μm, and the center distance (nozzle row length) of the discharge nozzles 78 at the two ends in the Y-axis direction is about 2,041.1 mm. In other words, there is formed a straight line in which 29,160 points are connected at a pitch interval of 70 μm when droplets are discharged one at a time from the discharge nozzles 78 of a single head unit group 150 and are made to land so as to be positioned in the same position in the X-axis direction.

### Mother Element Substrate

A mother element substrate 310A will be described next. The element substrate 301 is divided, whereby the mother element substrate 310A is divided and formed into individual element substrates 301 (glass substrate 310) after the organic EL elements 307 described above and the like have been formed on the mother element substrate 310A acting as the glass substrate 310. FIG. 21(b) shows the portion acting as the glass substrate 310 and the portion on which the display region 306 is formed. As shown in FIG. 21(b), 25 element substrates 301 are formed from the mother element substrate 310A. In the present embodiment, the term mother element substrate 310A is used for a substrate in which the organic EL elements 307 and the like are formed in the display region 306 on the mother element substrate 310A, and for a substrate in which the organic EL elements 307 and the like are in an intermediate state of formation.

The portion that will form the glass substrate 310 on the mother element substrate 310A and the position of the display region 306 is set in a position in which the arrangement pitch of the display regions 306 in the Y-axis direction is an integral multiple of the region pitch in the Y-axis direction of the pixel region 321 in which the display region 306 will be formed.

An alignment mark (not shown) is formed in a position that does not interfere with the region that will form the glass substrate 310 of the mother element substrate 310A. The alignment mark is used as a position reference mark, e.g., when the mother element substrate 310A is mounted on the droplet discharge device or another manufacturing device in order to carry out various steps for forming the organic EL elements 307 or the like.

### Arrangement of Functional Liquid on Mother Element Substrate

Next, the steps for depositing the hole-transport layer material liquid 560 in the pixel regions 321 of the mother element substrate 310A using the head unit group 150 will be described. The length of the unit group nozzle row 152 of the head unit group 150 is greater in the Y-axis direction than the width of five pixel regions 321 arranged in the Y-axis direction on the mother element substrate 310A, as shown in FIGS. 21(a) and 21(b). Accordingly, the hole-transport layer material liquid 560 can be deposited in a single discharge scan in all of the 25 pixel regions 321 arrayed on the mother element substrate 310A.

For example, a predetermined quantity of the hole-transport layer material liquid 560 is deposited in the pixel region 321 in four scans as described above in the section titled “Functional liquid arrangement.” In this case, the discharge scan is carried out four times and the secondary scan is carried out three time to deposit a predetermined quantity of the hole-transport layer material liquid 560 in all the pixel regions 321 on the mother element substrate 310A by suitably establishing the relative movement distance in the secondary scan. The relative movement distance in the secondary scan that satisfies this condition is a value that does not exceed the length of the unit group nozzle row 152. The value is obtained by adding the relative movement distance in three secondary scans and the width in the Y-axis direction of five pixel regions 321 on the mother element substrate 310A. All the pixel regions 321 on the mother element substrate 310A are thereby included in the partition scan regions of a single location as described above in the section titled “Functional Liquid Arrangement”, and a predetermined quantity of the hole-transport layer material liquid 560 is deposited in all the pixel regions 321 on the mother element substrate 310A in a single cycle of the partition scan. The relative movement distance in three secondary scans included in a single cycle of a partition scan is an integral multiple of the region pitch, which is the arrangement pitch of the pixel regions 321 in the Y-axis direction.

Since a predetermined quantity of the hole-transport layer material liquid 560 is deposited in all the pixel regions 321 in a single cycle of the partition scan, a partition secondary scan is not carried out for moving the discharge nozzles in a relative fashion to a position facing the next partition scan region. Therefore, the relative movement distance in the secondary scan is an integral multiple of the region pitch in the all the secondary scans.

Thus, the relative movement distance in the secondary scan is an integral multiple of the region pitch in all the secondary scans in the case that the hole-transport layer material liquid 560 is to be deposited in the pixel regions 321 of the mother element substrate 310A using the head unit group 150.

### Functional Liquid Arrangement-4

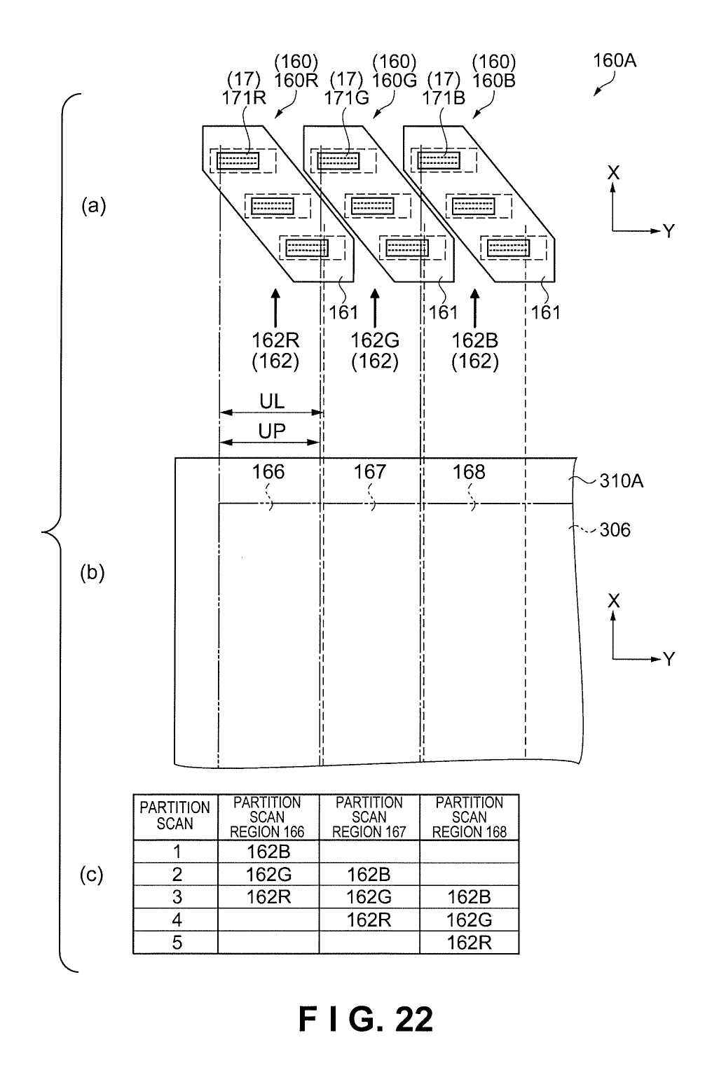

Described next with reference to FIG. 22 is another example of the step for discharging functional liquid from the droplet discharge head 17 of the droplet discharge device and depositing the functional liquid in a filter film region. The example of the present step is a step for depositing the luminescent layer material liquid 570 in the pixel region 321 of the display region 306. FIG. 22 is a descriptive view showing the relationship between the display region and the arrangement of the droplet discharge head for performing discharges in the step for depositing the luminescent layer material liquid. FIG. 22(a) is a plan view showing the general configuration of the head unit group. FIG. 22(b) is a plan view showing the partition scan regions in the display region. FIG. 22(c) is a table of the head assemblies for carrying out discharge in each partition scan region.

The head unit 160A shown in FIG. 22(a) is provided with three head assembly units 160. The head assembly unit 160 has a carriage plate 161, and three droplet discharge heads 17 mounted on the carriage plate 161. The three droplet discharge heads 17 correspond to the head assembly 62 in the head unit 21 and are secured to the carriage plate 161 using the same mounting structure and positional relationship with the three droplet discharge heads 17 in the single head assembly 62 in the head unit 21. The head assembly units 160 are moved in the Y-axis direction using the same Y-axis table as the Y-axis table 12 described above, whereby the droplet discharge heads 17 are freely moved in the Y-axis direction and kept in the moved position. The X-axis and Y-axis shown in FIG. 22(a) match the X-axis and Y-axis shown in FIG. 1 in a state in which the head unit 160A is mounted on the droplet discharge device in the same manner that the head unit 21 is mounted on the droplet discharge device 1.

The head unit 160A has a configuration in which three types of functional liquid corresponding to a tri-colored filter are deposited, and the three head assembly units 160 are a head assembly unit 160R provided to the red head assembly 162R, a head assembly unit 160G provided to the green head assembly 162G, and a head assembly unit 160B provided to the blue head assembly 162B.

The red head assembly 162R is composed of a red discharge head 171R for discharging luminescent layer material liquid 570R containing a material for forming a red luminescent layer 317R. The red head assembly 162R is provided with three red discharge heads 171R. The green head assembly 162G is composed of a green discharge head 171G for discharging luminescent layer material liquid 570G containing a material for forming a green luminescent layer 317G. The green head assembly 162G is provided with three green discharge heads 171G. The blue head assembly 162B is composed of a blue droplet discharge head 171B for discharging blue luminescent layer material liquid 570B containing a material for forming a blue luminescent layer 317B.

As described above, the head assembly unit 160R provided with the red head assembly 162R, the head assembly unit 160G provided with the green head assembly 162G, and the head assembly unit 160B provided with the blue head assembly 160B in the head unit 160A can be independently moved in the Y-axis direction, and the distances therebetween can be adjusted. The positional relationship between the red head assembly 162R, the green head assembly 162G, and the blue head assembly 162B in the head unit 160A is different from the positional relationship between the red head assembly 62R, the green head assembly 62G, and the blue head assembly 62B in the head unit 121 only in that the mutual distances in the Y-axis direction can be adjusted.

The movement mechanism for moving the head assembly unit 160R, the head assembly unit 160G, and the head assembly unit 160B independently in the Y-axis direction, the CPU 44 for outputting control signals that control the movement distance, and the drive mechanism driver 40d for driving the movement mechanism in accordance with control signals correspond to nozzle row spacing adjustment section.

The center distance of the discharge nozzles 78 at the two ends of the head assembly nozzle row of the head assembly 162 is referred to as the “nozzle row length UL.” In the head unit 160A shown in FIG. 22(a), the arrangement pitch of the head assembly nozzle rows of the head assembly 162 is referred to as the “nozzle row pitch UP.”

The discharge scan is carried out in units of the red head assembly 162R, the green head assembly 162G, or the blue head assembly 162B. The nozzle row for depositing droplets in substantially the same position in the X-axis direction is a head assembly nozzle row of the head assembly 162 provided to the head assembly unit 160. A partition scan region 166, a partition scan region 167, and a partition scan region 168 have a width that corresponds to the nozzle row pitch UP as shown in FIG. 22(b).

In the first partition scan 1, the luminescent layer material liquid 570B is deposited in the pixel region 321 in which the blue luminescent layer 317B in the partition scan region 166 is formed by the blue head assembly 162B, as shown in FIG. 22(c).

Next, in partition scan 2, the luminescent layer material liquid 570B is deposited in the pixel region 321 in which the blue luminescent layer 317B in the partition scan region 167 is formed by the blue head assembly 162B, and the luminescent layer material liquid 570G is deposited in the pixel region 321 in which the green luminescent layer 317G in the partition scan region 166 is formed by the green head assembly 162G.

Then, in partition scan 3, the luminescent layer material liquid 570B is deposited in the pixel region 321 in which the blue luminescent layer 317B in the partition scan region 168 is formed by the blue head assembly 162B, the luminescent layer material liquid 570G is deposited in the pixel region 321 in which the green luminescent layer 317G in the partition scan region 167 is formed by the green head assembly 162G, and the luminescent layer material liquid 570R is deposited in the pixel region 321 in which the red luminescent layer 317R in the partition scan region 166 is formed by the red head assembly 162R.

Subsequently, in partition scan 4, the luminescent layer material liquid 570G is deposited in the pixel region 321 in which the green luminescent layer 317G in the partition scan region 168 is formed by the green head assembly 162G, and the luminescent layer material liquid 570R is deposited in the pixel region 321 in which the red luminescent layer 317R in the partition scan region 167 is formed by the red head assembly 162R.

Next, in partition scan 5, the luminescent layer material liquid 570R is deposited in the pixel region 321 in which the red luminescent layer 317R in the partition scan region 168 is formed by the red head assembly 162R.

The luminescent layer material liquid 570R, the luminescent layer material liquid 570G, and the luminescent layer material liquid 570B are deposited in the pixel regions 321 in the partition scan region partition scan region 166, the partition scan region 167, and the partition scan region 168, respectively, by carrying out partition scans 1 through 5.

In the first partition scan 1, there is a pixel region 321 in the first, second, and third discharge scans in which the luminescent layer material liquid 570B cannot be deposited in the pixel region 321 of the partition scan region 167 side in the partition scan region 166 depending on the nozzle row pitch UP, and a specified quantity of the luminescent layer material liquid 570B cannot be deposited in the pixel region 321. However, in the first, second, and third discharge scans of the subsequent partition scan 2, the discharge nozzles 78 on the partition scan region 166 side in the nozzle row facing the partition scan region 167 is positioned facing the pixel region 321. Accordingly, the luminescent layer material liquid 570B that is less than a specified quantity can be supplemented in the partition scan 2 in the pixel region 321 which the specified quantity of the luminescent layer material liquid 570B could not be deposited in the partition scan 1 using the discharge nozzles 78. The same applies to the other partition scan region 167 and partition scan region 168, and the same applies to luminescent layer material liquid 570 other than the luminescent layer material liquid 570B.

Since nozzle row pitch UP is variable, the magnitude of the nozzle row pitch UP can be set to a value in which there is no pixel region 321 in which the luminescent layer material liquid 570 cannot be deposited in the first, second, and third discharge scans as well of the first partition scan 1.

In the partition scans 1 though 5 described above, the width in which the functional liquid is deposited in the first discharge scan in the partition scans 1 through 5 is an integral multiple of the region pitch, which is the arrangement pitch of the pixel regions 321 in the Y-axis direction in the same manner as the section titled “Functional liquid arrangement” described above. The width of the partition scan region in the Y-axis direction is an integral multiple of the region pitch because the width in which the luminescent layer material liquid 570 is deposited is set to the same width in the second to fourth discharge scans as well. In this case, the drive voltage and other drive conditions of the discharge nozzles 78 are kept as constant drive conditions without adjustment because there is substantially no fluctuation in the discharge quantity due to the effect of fluctuations in the drive state of nearby discharge nozzles 78. The partition secondary scan in this case corresponds to the first secondary scan and the partition secondary scan step corresponds to the first secondary scan step.

As described above, the partition scan region 166, the partition scan region 167, and the partition scan region 168 have a width that corresponds to the nozzle row pitch UP. The relative movement distance is an integral multiple of the region pitch in the partition secondary scans performed between the partition scans 1 through 5 because the nozzle row pitch UP is an integral multiple of the region pitch, which is the arrangement pitch of the pixel regions 321 in the Y-axis direction.

Thus, the relative movement distance in the secondary scan is an integral multiple of the region pitch in all the secondary scans in the case that the luminescent layer material liquid 570R, the luminescent layer material liquid 570G, and the luminescent layer material liquid 570B are deposited in the pixel region 321 of the mother element substrate 310A using the head unit 160A.

The effects of the second embodiment are described below. According to the second embodiment, the following effects are obtained.

(1) The relative movement distance in the discharge scan is an integral multiple of the region pitch in all the secondary scans when the functional liquid is deposited in the pixel region 321 of the mother element substrate 310A. The discharge-performing array in the secondary scans can thereby be kept constant in the nozzle rows of most of the droplet discharge heads 17 constituting the unit group nozzle row 152. The nozzle rows in which the discharge-performing array is not constant are nozzle rows that contain discharge nozzles 78 that face an area between the display regions 306 and may not perform a discharge in the four discharge scans.

(2) The arrangement pitch of the display regions 306 in the Y-axis direction is an integral multiple of the region pitch of the pixel regions 321. The position that the discharge nozzles 78 face in the pixel region 321 that the discharge nozzles 78 are facing can be made to be substantially the same even when the display region 306 that the discharge nozzles 78 are facing changes because the relative movement distance in the secondary scan is an integral multiple of the region pitch.

(3) The head assembly unit 160R provided with the red head assembly 162R, the head assembly unit 160G provided with the green head assembly 162G, and the blue head assembly 160B provided with the blue head assembly 162B in the head unit 160A can be moved independently in the Y-axis direction, and the distances therebetween can be adjusted. The nozzle row pitch between the head assembly nozzle rows of the head assemblies can therefore be adjusted.

(4) The relative movement distance in the partition secondary scans performed in the partition scans 1 through 5 can be set to be an integral multiple of the region pitch by setting the nozzle row pitch UP to be an integral multiple of the region pitch, which is the arrangement pitch of the pixel regions 321 in the Y-axis direction. Thus, the relative movement distance in the secondary scan can be set to an integral multiple of the region pitch in all the secondary scans in the case that the luminescent layer material liquid 570R, the luminescent layer material liquid 570G, and the luminescent layer material liquid 570B are deposited in the pixel region 321 of the mother element substrate 310A using the head unit 160A.

Advantageous embodiments were described above with reference to the drawings, but advantageous embodiments are not limited the embodiments described above. As shall be apparent, it is possible to make various modifications within a range that does not depart from the spirit of the invention and it is also possible to implement embodiments as described below.

### Modified Example 1

In the embodiments described above, nozzle rows having a considerable print width were configured using a head unit 21 or another head unit having a combination of a plurality of droplet discharge heads 17, but it is not required that the nozzle rows be configured using numerous droplet discharge heads. For example, it is also possible to use a single droplet discharge head provided with a nozzle row having the same length as the unit group nozzle row 152 of the head unit group 150.

A configuration in which the nozzle rows are formed using a single droplet discharge head is more advantageous than a configuration in which the nozzle rows are formed using numerous droplet discharge heads, in that a single carriage or the like is used, positioning between the droplet discharge heads is not required, the head unit configuration is simple, and control of the head unit is simple.

On the other hand, the configuration in which the nozzle rows are formed using a plurality of droplet discharge heads has an advantage in that the individual heads are small and readily fabricated, an advantage in that the nozzle row section can be replaced in units of individual droplet discharge heads, and other advantages.

### Modified Example 2

In the embodiments described above, the droplet discharge heads 17 mutually adjacent in the Y-axis direction have a configuration in which the endmost discharge nozzles 78 are arranged at the center distance of a single nozzle pitch (one-half of nozzle pitch P of the discharge nozzles 78 in the nozzle rows 78A) in the head unit 21 and the head unit group 150. However, there is also a method in which the discharge nozzles in the center area in which the discharge quantity readily stabilizes are used, and the some of the discharge nozzles at the end of the nozzle rows in the droplet discharge head as such are not used for discharge. In the case that such a method is used, a preferred configuration is one in which the endmost discharge nozzles of the discharge nozzles to be used are arranged using the center distance of a single nozzle pitch.

### Modified Example 3

In the second embodiment described above, an example was described in which the hole-transport layer material liquid 560 is deposited using the head unit group 150 in the section titled “Functional liquid arrangement-3,” but a plurality of types of liquids may be aligned and deposited using a nozzle row having a length that allows the liquid to be deposited over the entire surface of the substrate in a single partition scan. For example, the red functional liquid 252R, the green functional liquid 252G, and the blue functional liquid 252B may be aligned and deposited using the head unit group 150. It is possible to use in the head unit group 150 individual droplet discharge heads 17 or the like, or a head assembly composed of three mutually adjacent head units 151, individual head units 151, or three droplet discharge heads 17, as a unit for discharging the same type of functional liquid.

When three mutually adjacent head units 151, or individual head units 151 are used as a unit for discharging the same functional liquid, it is also possible to adjust the nozzle row pitch between the nozzle rows of the individual head units 151 or the three head units 151 and set the nozzle row pitch to an integral multiple of the functional film pitch.

### Modified Example 4

In the embodiments described above, four discharge scans and three secondary scans are performed for each partition scan, but the number of discharge scans per partition scan is not limited. Any of the manufacturing methods described above may be used even if the number of discharge scans per partition scan is a single discharge scan in the case that it is possible to deposit sufficient liquid in all the functional film partitioned areas in a single discharge scan and the functional liquid arrangement requires a partition secondary scan.

### Modified Example 5

In the embodiments described above, the droplet discharge head 17 has a configuration in which a single type of functional liquid is discharged, but the droplet discharge head may have a configuration provided with a plurality of liquid feed channels and a nozzle row to which the liquid feed channels are in communication and feed liquid.

### Modified Example 6

In the embodiments described above, the droplet discharge head 17 is provided with two nozzle rows 78A and has a configuration having 180 discharge nozzles 78 in each nozzle row 78A. However, the configuration of the discharge nozzles in the droplet discharge head is not limited to a configuration such as that in droplet discharge head 17. The droplet discharge head may have any number of discharge nozzles, and the discharge nozzles in the droplet discharge head may be, e.g., in a single-row or any other arrangement.

### Modified Example 7

In the embodiments described above, the head unit 21 of the droplet discharge device 1 is provided with nine droplet discharge heads 17, but the number of droplet discharge heads provided to the head unit is not limited to nine. The head unit has a configuration provided with any number of droplet discharge heads.

### Modified Example 8

In the embodiments described above, the droplet discharge device 1 is provided with a single head unit 21, and the droplet discharge device provided with the head unit group 150 has nine head units 151, but the head unit of the droplet discharge device is not limited to 1 or nine. The droplet discharge device may have a configuration provided with any number of head units.

### Modified Example 9

In the embodiments described above, the partition secondary scan is carried out after a single partition scan (four discharge scans and three secondary scans) has been completely carried out in a single partition scan region, but it is not required that the partition scan be completed between the partition secondary scans. The secondary scan in the partition scan and the partition secondary scan may be carried out in any order.

For example, a method is also possible in which a single secondary scan and partition secondary scan are repeated first, a secondary scan is carried a single time for all of the partition scan regions on a substrate, and the remaining secondary scans are carried out with intervening secondary scans for each of the partition scan regions. The liquid is deposited in all of the partition scan regions in a single process, whereby it is possible to reduce the occurrence that the point in time in which the liquid is deposited in each position with an intervening boundary of the partition scan region within the functional film partition will be different in the functional film partition positioned in the boundary between the partition scan regions. It is possible that a uniform film will become difficult to form when the state of progress in drying is different due to the different points in time in which the divided liquid is deposited.

### Modified Example 10

In the embodiments described above, an example was described in which the relative movement distance is the region pitch GP acting as the functional film pitch, and is the relative movement distance in the secondary scan in which the array of discharge nozzles that perform a discharge in the nozzle row does not vary. However, the relative movement distance is not required to be the functional film pitch. The relative movement distance in the secondary scan can be an integral multiple of the functional film pitch in order kept the array of nozzles that perform a discharge in the nozzle row invariable.

### Modified Example 11

In the embodiments described above, the relative movement distance in the secondary scan is an integral multiple of the region pitch or an integral multiple of the nozzle pitch, but when the relative movement distance is not an integral multiple of the region pitch in the secondary scan, the relative movement distance is not required to be an integral multiple of the nozzle pitch. When the relative movement distance is not an integral multiple of the region pitch in the secondary scan, any relative movement distance can be used as long as the relative movement distance is capable of causing the discharge nozzles to efficiently face the region in which the liquid is to be deposited.

### Modified Example 12

In the embodiments described above, the droplet discharge device 1 deposits a functional liquid by moving the workpiece stage 23 on which the mother opposing substrate 201A or the like is disposed in the X-axis direction and discharging the functional liquid from the droplet discharge head 17. The droplet discharge head 17 (discharge nozzles 78) is positioned in relation to the mother opposing substrate 201A or the like by moving the head unit 21 in the Y-axis direction. The relative movement in the discharge scan is performed by moving the substrate in other examples as well, and the relative movement in the secondary scan is performed by moving the droplet discharge head having the nozzle rows. However, it is not required that the relative movement between the substrate and the droplet discharge head provided with the nozzle rows be performed in the discharge scan by moving the substrate, or that the relative movement in the secondary scan be performed by moving the droplet discharge head.

The relative movement in the discharge scan between the substrate and the droplet discharge head may be carried out by moving the droplet discharge head in the secondary scan direction. The relative movement in the secondary scan direction between the substrate and the droplet discharge head may be carried out by moving the substrate in the secondary scan direction. Alternatively, the relative movements in the discharge scan direction and the secondary scan direction between the substrate and the droplet discharge head may be carried out by moving the substrate or the droplet discharge head in the discharge scan direction and the secondary scan direction. Both the substrate and droplet discharge head may be moved in the discharge scan direction and the secondary scan direction.

### Modified Example 13

In the embodiments described above, the droplet discharge head 17 was an inkjet-type droplet discharge head, but the droplet discharge head is not required to be an inkjet-type droplet discharge head. The discharge head used in the method for manufacturing an electro-optical device and the discharge head provided to the apparatus for manufacturing an electro-optical device described above may be a droplet discharge head of a method other than the inkjet method.

### Modified Example 14

In the embodiments described above, the filter film region 225 and the pixel region 321 used as the functional film partitioned areas in which liquid is deposited are regions having a substantially quadrangular shape as view from above, but the shape of the region in which the liquid is to be deposited is not required to be substantially quadrangular. The shape of the region in which the liquid is to be deposited may be a polygonal shape other than a quadrangular shape, an elliptical shape, a circular shape, a polygonal shape having curved corners, a shape composed of a plurality of curves with differing curvatures, a shape in which the above shapes are partially notched, or another shape.

### Modified Example 15

In the embodiments described above, the drawing discharge carried out when the filter films 205, or the hole-transport layer 316 and the luminescent layer 317 are to be formed was described for the liquid crystal display panel 200 and the organic EL display device 300, which are examples of an electro-optical device, provided with a color filter, and the color filter is an example of a target for depositing a functional liquid using the droplet discharge device. However, the electro-optical device used as a target for depositing functional liquid is not limited to a liquid crystal device or an organic EL device. The electro-optical device as a target for depositing functional liquid may be any electro-optical device as long as it is a device having a film such as that described above or an electro-optical device that requires a film such as that described above to be formed in a formation process. The electro-optical device may be a plasma-type display device or another electro-optical device.

### Modified Example 16

In the second embodiment described above, the organic EL elements 307 had a configuration in which the hole-transport layer 316 and the luminescent layer 317 were sandwiched between the pixel electrodes 314 and the opposing electrodes 318, but the organic EL elements are not limited to such a configuration. Known configurations of the organic EL elements include configurations in which only the luminescent layer is sandwiched between the pixel electrodes and the opposing electrodes; configurations in which the hole-transport layer, the luminescent layer, and the electron-transport layer are in a sandwiched configuration; configurations in which the hole-transport layer, the luminescent layer, the electron-transport layer, and the hole-injection layer are in a sandwiched configuration; and configurations in which the hole-transport layer, the luminescent layer, the electron-transport layer, the hole-injection layer, and the electron injection layer are in a sandwiched configuration. The method for manufacturing an electro-optical device and the apparatus for manufacturing the electro-optical device described in the embodiments above may also be applied to the formation of the electron-transport layer, the hole-injection layer, and the electron injection layer.

### Modified Example 17

In the embodiments described above, the CF layer 208 of the liquid crystal display panel 200 had three color filters having three filter films, namely, a red filter film 205R, a green filter film 205G, and a blue filter film 205B, but the color filter may be a multicolored filter having many types of filter films. Examples of the multicolored filter include a color filter with six colors having, in addition to red, green, and blue, the organic EL elements cyan (blue green), magenta (purple red), yellow (yellow color) as complimentary colors of red, green, and blue; and a color filter with four colors in which green is included with cyan (blue green), magenta (purple red), and yellow (yellow color).

### Modified Example 18

In the embodiments described above, a CF layer 208 was described as a color filter provided to a liquid crystal display panel 200, but a color filter that can be advantageously manufactured using the film-formation method described above is not limited to a color filter of a liquid crystal display device. A color filter for an organic EL display device for forming a color organic EL display device can be advantageously manufactured in combination with a luminescent layer for emitting colored or colorless light by using the method for manufacturing an electro-optical device and the apparatus for manufacturing an electro-optical device described in the embodiments above.

### Modified Example 19

In the embodiments described above, the liquid crystal display panel 200 is an active matrix-type liquid crystal device that uses thin film transistors as drive elements, but the drive elements are not limited to TFT elements. The panel may be a liquid crystal device provided with other drive elements, e.g., a thin film diode (TFD). The method of aligning the liquid crystal device may be a vertical alignment or a horizontal alignment.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A method for manufacturing an electro-optical device comprising:
performing a discharge-scanning by moving a nozzle row including a plurality of discharge nozzles and a substrate including a plurality of functional film partitioned areas relative to each other in a direction perpendicular to an array direction of the discharge nozzles in the nozzle row and by selectively discharging liquid from the discharge nozzles to deposit the liquid in the film formation partitioned areas to form a functional film; and
performing a secondary scanning by moving the substrate and the nozzle row relative to each other in the array direction,
the performing of the secondary scanning including performing a first secondary scanning at least once in which a relative movement distance between the nozzle row and the substrate is equal to an integral multiple of an arrangement pitch of the film formation partitioned areas in the array direction.

2. The method for manufacturing an electro-optical device according to claim 1, further comprising
setting discharge drive conditions for each of the discharge nozzles so that the discharge drive conditions in the discharge-scanning performed after the first secondary scanning are set to the discharge drive conditions that are the same as the discharge drive conditions in the discharge-scanning carried out prior to the first secondary scanning.

3. The method for manufacturing an electro-optical device according to claim 2, wherein
the performing of the secondary scanning includes performing a second secondary scanning in which the relative movement distance per cycle is equal to an integral multiple of a nozzle pitch of the discharge nozzles in the nozzle row.

4. The method for manufacturing an electro-optical device according to claim 3, wherein
the setting of the discharge drive conditions includes setting the discharge drive conditions so that the discharge drive conditions performed after the second secondary scanning are set to the discharge drive conditions that are different than the discharge drive conditions carried out prior to the second secondary scanning.

5. The method for manufacturing an electro-optical device according to claim 1, further comprising
adjusting a spacing between a plurality of the nozzle rows in the array direction to be equal to an integral multiple of the arrangement pitch.

6. The method for manufacturing an electro-optical device according to claim 3, further comprising
adjusting a spacing between a plurality of the nozzle rows in the array direction to be equal to an integral multiple of the nozzle pitch.

7. The method for manufacturing an electro-optical device according to claim 1, further comprising
providing as the substrate a mother panel including a plurality of electro-optical panels each corresponding to a single electro-optical device so that a plurality of functional film formation regions of the electro-optical panel are arranged in the secondary scanning direction in an integral multiple of the arrangement pitch.

8. An apparatus for manufacturing an electro-optical device comprising:
a nozzle row including a plurality of discharge nozzles;
a movement mechanism configured and arranged to move the nozzle row and a substrate including a plurality of functional film partitioned areas relative to each other; and
a control section configured to control the movement mechanism and the nozzle row to perform a discharge-scanning by moving the nozzle row and the substrate relative to each other in a direction perpendicular to an array direction of the discharge nozzles in the nozzle row and by selectively discharging liquid from the discharge nozzles to deposit the liquid in the film formation partitioned areas to form a functional film, and to control the movement mechanism to perform a secondary scanning by moving the substrate and the nozzle row relative to each other in the array direction, the control section being configured to control the movement mechanism to perform a first secondary scanning in which a relative movement distance between the nozzle row and the substrate is equal to an integral multiple of an arrangement pitch of the film formation partitioned areas in the array direction.

9. The apparatus for manufacturing an electro-optical device according to claim 8, further comprising
a drive conditions setting section configured and arranged to set discharge drive conditions for each of the discharge nozzles so that the discharge drive conditions in the discharge-scanning performed after the first secondary scanning are set to the discharge drive conditions that are the same as the discharge drive conditions in the discharge-scanning carried out prior to the first secondary scanning.

10. The apparatus for manufacturing an electro-optical device according to claim 9, wherein
the control section is configured to control the movement mechanism to perform a second secondary scanning in which the relative movement distance per cycle is equal to an integral multiple of a nozzle pitch of the discharge nozzles in the nozzle row, and
the drive conditions setting section is configured to set the discharge drive conditions so that the discharge drive conditions performed after the second secondary scanning are set to the discharge drive conditions that are different than the discharge drive conditions carried out prior to the second secondary scanning.

11. The apparatus for manufacturing an electro-optical device according to claim 8, further comprising
a plurality of the nozzle rows with a spacing between the nozzle rows in the array direction is equal to an integral multiple of the arrangement pitch.

12. The apparatus for manufacturing an electro-optical device according to claim 10, further comprising
a plurality of the nozzle rows with a spacing between the nozzle rows in the array direction is equal to an integral multiple of the nozzle pitch.

13. The apparatus for manufacturing an electro-optical device according to claim 8, further comprising
a nozzle row spacing adjustment section configured and arranged to adjust a spacing between a plurality of the nozzle rows in the array direction.
